(19) United States
(12) Patent Application Publication
(10) Pub. No.: US 2009/0231268 A1
(43) Pub. Date: Sep. 17, 2009

(54) ELECTROPHORETIC DISPLAY DEVICE, METHOD OF DRIVING ELECTROPHORETIC DISPLAY DEVICE, AND ELECTRONIC APPARATUS

(75) Inventor: Toshimichi Yamada, Suwa-gun (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/389,578

(22) Filed: Feb. 20, 2009

(30) Foreign Application Priority Data
Mar. 14, 2008 (JP) 2008-066225
Sep. 26, 2008 (JP) 2008-247701

(51) Int. Cl. G09G 3/34

(52) U.S. Cl. 345/107

(57) ABSTRACT

An electrophoretic display device includes a display unit that is formed so that electrophoretic elements containing electrophoretic particles are held between a pair of substrates. The display unit is formed of a plurality of pixels. Each of the pixels includes a pixel electrode, a pixel switching element, and a latch circuit connected between the pixel electrode and the pixel switching element. A plurality of the pixels located in at least portion of the display unit each are any one of a first pixel and a second pixel. The first pixel satisfies a relationship that the gate capacitance charging time of a P-MOS transistor of a transfer inverter of the latch circuit is shorter than the gate capacitance charging time of a P-MOS transistor of a feedback inverter of the latch circuit, a relationship that the gate capacitance charging time of an N-MOS transistor of the transfer inverter is longer than the gate capacitance charging time of an N-MOS transistor of the feedback inverter, or both the relationships. The second pixel satisfies a relationship that the gate capacitance charging time of a P-MOS transistor of a transfer inverter of the latch circuit is longer than the gate capacitance charging time of a P-MOS transistor of a feedback inverter of the latch circuit, a relationship that the gate capacitance charging time of an N-MOS transistor of the transfer inverter is shorter than the gate capacitance charging time of an N-MOS transistor of the feedback inverter, or both the relationships.

### BACKGROUND

1. Technical Field

The invention relates to an electrophoretic display device, a method of driving the electrophoretic display device, and an electronic apparatus.

2. Related Art

A known active matrix electrophoretic display device includes a switching transistor and a memory circuit (SRAM: Static Random Access Memory) in a pixel (see JP-A-2003-84314). A display device described in JP-A-2003-84314 is formed so that microcapsules that contain electrically charged particles are adhered on a substrate on which switching transistors and pixel electrodes are formed. Then, the electrically charged particles are controlled using an electric field generated between the pixel electrodes and a common electrode, which hold the microcapsules in between, to thereby display an image.

In the electrophoretic display device described in JP-A-2003-84314, in order to display black and white of an image, an SRAM (pixel SRAM circuit) provided in each pixel stores any one of binary black and white as an electric potential (high level or low level). Then, a voltage based on the stored electric potential is applied to microcapsules to perform display. In addition, the electrophoretic display device has such a feature that the microcapsule, which is a display body, has a holding capability (storage capability). By interrupting power supply after a display operation, it is possible to hold an image without consuming electric power.

When an image holding period during which power is interrupted is provided, it is necessary to supply power to the pixel SRAM circuit again when updating a display image. The pixel SRAM circuit loses memory content due to interruption of power and, in addition, it is not clear which binary state the SRAM holds at the instant at which the power is turned on. This is because the state of the SRAM is influenced by a parasitic capacitance of the circuit and how the power rises. Therefore, it is impossible to directly display an image in a state immediately after power is turned on, and it is necessary to transfer display image data again to the pixel SRAM circuit.

### SUMMARY

An advantage of some aspects of the invention is that it provides an electrophoretic display device that is able to display a predetermined image immediately after power is turned on, and a method of driving the electrophoretic display device.

An aspect of the invention provides an electrophoretic display device. The electrophoretic display device includes a display unit that is formed so that electrophoretic elements containing electrophoretic particles are held between a pair of substrates. The display unit is formed of a plurality of pixels. Each of the pixels includes a pixel electrode, a pixel switching element, and a latch circuit connected between the pixel electrode and the pixel switching element. A plurality of the pixels located in at least portion of the display unit each are any one of a first pixel and a second pixel. The first pixel satisfies a relationship that the gate capacitance charging time of a P-MOS transistor of a transfer inverter of the latch circuit is shorter than the gate capacitance charging time of a P-MOS transistor of a feedback inverter of the latch circuit, a relationship that the gate capacitance charging time of an N-MOS transistor of the transfer inverter is longer than the gate capacitance charging time of an N-MOS transistor of the feedback inverter, or both the relationships. The second pixel satisfies a relationship that the gate capacitance charging time of a P-MOS transistor of a transfer inverter of the latch circuit is longer than the gate capacitance charging time of a P-MOS transistor of a feedback inverter of the latch circuit, a relationship that the gate capacitance charging time of an N-MOS transistor of the transfer inverter is shorter than the gate capacitance charging time of an N-MOS transistor of the feedback inverter, or both the relationships.

In the first pixel and second pixel that are used as pixels that constitute the display unit of the aspect of the invention, the respective latch circuits are configured so that the duration of the gate capacitance charging time of each transistor satisfies a specific relationship. Thus, in the first pixel, when power of the latch circuit, which is in a turn-off state, is turned on, the latch circuit definitely becomes stable in a state in which a low level electric potential is held (state in which the P-MOS transistor of the transfer inverter and the N-MOS transistor of the feedback inverter are turned on). On the other hand, in the second pixel, after power is turned on, the latch circuit becomes stable in a state in which a high level electric potential is held (state in which the N-MOS transistor of the transfer inverter and the P-MOS transistor of the feedback inverter are turned on). That is, in the electrophoretic display device of the aspect of the invention, when power of the display unit is turned on, each pixel of the display unit enters a state similar to a state that a predetermined image signal is written. Thus, when the first and second pixels are, for example, arranged so as to form a specific image, it is possible to display the specific image immediately after power is turned on. In addition, because it is not necessary to transmit image signals for the above image display operation, the image display operation may be executed in a state in which driving circuits are interrupted. Thus, it is advantageous in that almost no electric power is consumed.

In the above electrophoretic display device, a plurality of the pixels located in at least portion of the display unit each may be any one of a first pixel and a second pixel, wherein, in the first pixel, the channel width of a P-MOS transistor of a transfer inverter of the latch circuit is larger than the channel width of a P-MOS transistor of a feedback inverter of the latch circuit, and the channel width of an N-MOS transistor of the transfer inverter is smaller than the channel width of an N-MOS transistor of the feedback inverter, and wherein, in the second pixel, the channel width of a P-MOS transistor of a transfer inverter of the latch circuit is smaller than the channel width of a P-MOS transistor of a feedback inverter of the latch circuit, and the channel width of an N-MOS transistor of the transfer inverter is larger than the channel width of an N-MOS transistor of the feedback inverter.

In the first pixel and second pixel that are used as pixels that constitute the display unit of the aspect of the invention, the sizes of the channel widths of the transistors satisfy a specific relationship in each of the latch circuits provided for the first pixel and the second pixel. Thus, in the first pixel, when power of the latch circuit, which is in a turn-off state, is turned on, the latch circuit definitely becomes stable in a state in which a low level electric potential is held (state in which the P-MOS transistor of the transfer inverter and the N-MOS transistor of the feedback inverter are turned on). On the other hand, in the second pixel, after power is turned on, the latch circuit becomes stable in a state in which a high level electric potential is held (state in which the N-MOS transistor of the transfer inverter and the P-MOS transistor of the feedback inverter are turned on). That is, in the electrophoretic display device of the aspect of the invention, when power of the display unit is turned on, each pixel of the display unit enters a state similar to a state that a predetermined image signal is written. Thus, when the first and second pixels are, for example, arranged so as to form a specific image, it is possible to display the specific image immediately after power is turned on. In addition, because it is not necessary to transmit image signals for the above image display operation, the image display operation may be executed in a state in which driving circuits are interrupted. Thus, it is advantageous in that almost no electric power is consumed.

In the above electrophoretic display device, a plurality of the pixels located in at least portion of the display unit each may be any one of a first pixel and a second pixel, wherein, in the first pixel, the channel length of a P-MOS transistor of a transfer inverter of the latch circuit is smaller than the channel length of a P-MOS transistor of a feedback inverter of the latch circuit, and the channel length of an N-MOS transistor of the transfer inverter is larger than the channel length of an N-MOS transistor of the feedback inverter, and wherein, in the second pixel, the channel length of a P-MOS transistor of a transfer inverter of the latch circuit is larger than the channel length of a P-MOS transistor of a feedback inverter of the latch circuit, and the channel length of an N-MOS transistor of the transfer inverter is smaller than the channel length of an N-MOS transistor of the feedback inverter.

With the above configuration as well, the first and second pixels definitely become stable at a predetermined electric potential after power is turned on due to a difference in gate capacitance charging time based on a difference in channel length between the transistors of each latch circuit. Thus, it is possible to obtain the function and advantageous effects similar to the above described configuration.

In the above electrophoretic display device, a plurality of the pixels located in at least portion of the display unit each may be any one of a first pixel and a second pixel, wherein, in the first pixel, the number of gates of a P-MOS transistor of a transfer inverter of the latch circuit is smaller than the number of gates of a P-MOS transistor of a feedback inverter of the latch circuit, and the number of gates of an N-MOS transistor of the transfer inverter is larger than the number of gates of an N-MOS transistor of the feedback inverter, and wherein, in the second pixel, the number of gates of a P-MOS transistor of a transfer inverter of the latch circuit is larger than the number of gates of a P-MOS transistor of a feedback inverter of the latch circuit, and the number of gates of an N-MOS transistor of the transfer inverter is smaller than the number of gates of an N-MOS transistor of the feedback inverter.

With the above configuration as well, the first and second pixels definitely become stable at a predetermined electric potential after power is turned on due to a difference in gate capacitance charging time based on a difference in number of gates between the transistors of each latch circuit. Thus, it is possible to obtain the function and advantageous effects similar to the above described configuration.

In the above electrophoretic display device, a plurality of the pixels located in at least portion of the display unit each may be any one of a first pixel and a second pixel, wherein, in the first pixel, the LDD length of a P-MOS transistor of a transfer inverter of the latch circuit is smaller than the LDD length of a P-MOS transistor of a feedback inverter of the latch circuit, and the LDD length of an N-MOS transistor of the transfer inverter is larger than the LDD length of an N-MOS transistor of the feedback inverter, and wherein, in the second pixel, the LDD length of a P-MOS transistor of a transfer inverter of the latch circuit is larger than the LDD length of a P-MOS transistor of a feedback inverter of the latch circuit, and the LDD length of an N-MOS transistor of the transfer inverter is smaller than the LDD length of an N-MOS transistor of the feedback inverter.

With the above configuration as well, the first and second pixels definitely become stable at a predetermined electric potential after power is turned on due to a difference in gate capacitance charging time based on a difference in LDD length between the transistors of each latch circuit. Thus, it is possible to obtain the function and advantageous effects similar to the above described configuration.

In the above electrophoretic display device, a plurality of the pixels located in at least portion of the display unit each may be any one of a first pixel and a second pixel, wherein the first pixel has a capacitor, of which one of electrodes is connected to an input terminal of a transfer inverter of the latch circuit, and wherein the second pixel has a capacitor, of which one of electrodes is connected to an input terminal of a feedback inverter of the latch circuit. With the above configuration as well, the first and second pixels definitely become stable in a predetermined electric potential after power is turned on. Thus, it is possible to obtain the function and advantageous effects similar to the above described configuration.

In the above electrophoretic display device, a plurality of the pixels located in at least portion of the display unit each may be any one of a first pixel and a second pixel, wherein the first pixel has a resistance element connected between a feedback inverter of the latch circuit and a high-potential power supply line, and wherein the second pixel has a resistance element connected between a transfer inverter of the latch circuit and a high-potential power supply line.

With the above configuration as well, a difference in gate capacitance charging time of each transistor that constitutes each inverter occurs owing to a difference in charging electric current due to the resistance, and the first and second pixels definitely become stable at a predetermined electric potential after power is turned on due to the above difference. Thus, it is possible to obtain the function and advantageous effects similar to the above described configuration.

The other one of the electrodes of the capacitor may be connected to a low-potential power supply line together with a low-potential power supply terminal of the latch circuit. With the above configuration, it is not necessary to provide a wire for the capacitor. Thus, it may be easily applied to an electrophoretic display device that has high-resolution pixels.

The at least portion of the display unit each may be formed of only any one of the first pixel and the second pixel. With the above configuration, the display unit, after power is turned on, enters a state similar to that all the pixels in the portion in which the first pixels or the second pixels are arranged hold the same gray-scale image signal. Then, when this state is utilized, it is possible to perform deletion of an image with an extremely low power consumption. Furthermore, all the pixels of the display unit each may be formed of only any one of the first pixel and the second pixel. With the above configuration, the display unit, after power is turned on, enters a state similar to that all the pixels hold the same gray-scale image signal. Then, when this state is utilized, it is possible to perform deletion of an image on the entire display unit with an extremely low power consumption.

Each pixel may include a switch circuit that is connected between the latch circuit and the pixel electrode and that is connected between first and second control lines provided for the display unit. With the above configuration, a display mode (inversion display, all white and all black display, and the like) may be controlled by controlling an electric potential input to the first and second control lines. Thus, it is possible to enhance controllability of the display unit.

In the electrophoretic display device, an initial image display period during which an operation to supply power to each latch circuit and an operation to apply a voltage to each electrophoretic element without inputting an image signal to each latch circuit are executed may be provided. With the above configuration that the initial image display period is provided, the electrophoretic display device is able to display a specific image without consuming almost no electric power.

The electrophoretic display device may further include a control unit that controls driving of the display unit and a power supply voltage monitoring circuit that is connected to the control unit and that monitors a power supply voltage, wherein the control unit may be configured to execute a stand-by step in which power supplied to the display unit is interrupted on the basis of an alarm signal output from the power supply voltage monitoring circuit and an initial image display step in which power is supplied to the display unit and a voltage is applied to each electrophoretic element. With the above configuration, the electrophoretic display device is able to display an alarm image (initial image) on the display unit when a power supply voltage is low. Because the initial image display operation according to the aspects of the invention consumes almost no electric power, it is possible to substantially definitely display an alarm image even when a power supply voltage is low.

In the stand-by step, power supplied to a portion of circuits of the control unit may be interrupted. With the above configuration, when a power supply voltage is low, it is possible to save power consumption in the control unit. Thus, electric power for alarm image display is easily ensured.

Another aspect of the invention provides a driving method for an electrophoretic display device. The driving method for any one of the electrophoretic display devices described above includes displaying an initial image on the display unit by supplying power to each latch circuit in a turn-off state and applying a voltage to each electrophoretic element through each pixel electrode. With the above driving method, it is possible to display a specific image utilizing the characteristics of the first and second pixels without consuming almost no electric power.

The initial image may be displayed on the display unit when the electrophoretic display device starts up. That is, in the driving method according to the aspects of the invention, it is possible to instantaneously display a specific image (logo, or the like) immediately after power is turned on when the electrophoretic display device starts up.

The initial image may be displayed between a period during which at least each latch circuit is turned off and an image display period during which image data are transferred to the display unit and then an image based on the image data is displayed. With the above driving method, when an image on the display unit is updated, it is possible to display a predetermined image on the display unit. For example, when the display unit is formed of only the first or second pixel, it is possible to execute deletion of an image in the image update operation with an extremely low power consumption.

The electrophoretic display device may include a power supply voltage monitoring circuit that monitors a power supply voltage, wherein an alarm image may be displayed on the display unit when the power supply voltage monitoring circuit detects that the power supply voltage is lower than a predetermined value. With the above driving method, when a power supply voltage is low, it is possible to save power consumption in the control unit. Thus, it is possible to display an alarm image.

The driving method may further include interrupting power supplied to a portion of circuits of the electrophoretic display device before the initial image is displayed. With the above driving method, electric power for alarm image display is easily ensured.

Further another aspect of the invention provides an electronic apparatus that includes the electrophoretic display device of the above described aspects of the invention. With the above configuration, it is possible to provide an electronic apparatus that has a high-performance display device with low power consumption.

### BRIEF DESCRIPTION OF THE DRAWINGS

The invention will be described with reference to the accompanying drawings, wherein like numbers reference like elements.

FIG. 1 is a schematic block diagram of an electrophoretic display device according to a first embodiment.

FIG. 2A is a circuit configuration diagram of a first pixel, and FIG. 2B is a circuit configuration diagram of a second pixel.

FIG. 3 is a partially cross-sectional view of the electrophoretic display device according to the embodiment.

FIG. 4 is a schematic cross-sectional view of a microcapsule.

FIG. 5A and FIG. 5B are views illustrating the operation of an electrophoretic element.

FIG. 6A is a circuit configuration diagram of a first pixel, and FIG. 6B is a circuit configuration diagram of a second pixel according to a second embodiment.

FIG. 7 is a flowchart that shows a first driving method.

FIG. 8 is a timing chart in the first driving method.

FIG. 9A, FIG. 9B and FIG. 9C are views that illustrate changes in state of a display unit through the first driving method.

FIG. 10 is a flowchart that shows a second driving method.

FIG. 11 is a timing chart in the second driving method.

FIG. 12A, FIG. 12B and FIG. 12C are views that illustrate changes in state of a display unit through the second driving method.

FIG. 13 is a flowchart that shows a third driving method.

FIG. 14 is a timing chart in the third driving method.

FIG. 15A, FIG. 15B and FIG. 15C are views that illustrate changes in state of a display unit through the third driving method.

FIG. 16 is a schematic block diagram of an electrophoretic display device according to a third embodiment.

FIG. 17 is a circuit configuration diagram of a pixel according to the third embodiment.

FIG. 18 is a view that shows a watch, which is an example of an electronic apparatus.

FIG. 19 is a view that shows an electronic paper, which is an example of an electronic apparatus.

FIG. 20 is a view that shows an electronic notebook, which is an example of an electronic apparatus.

FIG. 21 is a plan view of a pixel according to an example embodiment.

FIG. 22 is a plan view of a latch circuit according to a first example embodiment.

FIG. 23 is a plan view of a latch circuit according to a second example embodiment.

FIG. 24 is a plan view of a latch circuit according to a third example embodiment.

FIG. 25 is a plan view of a latch circuit according to a fourth example embodiment.

FIG. 26 is a plan view of a latch circuit according to a fifth example embodiment.

FIG. 27A is a circuit diagram of a latch circuit according to a sixth example embodiment, and FIG. 27B is a plan view of the latch circuit according to the sixth example embodiment.

### DESCRIPTION OF EXEMPLARY EMBODIMENTS

Hereinafter, an active matrix electrophoretic display device according to an embodiment of the invention will be described with reference to the accompanying drawings. Note that the present embodiment is only illustrative and does not intend to limit the invention. The embodiment may be selectively modified within the scope of the technical idea of the invention. In addition, in the following drawings, to easily understand each configuration, the scale, number, and the like, in each structure are varied from an actual structure.

### First Embodiment

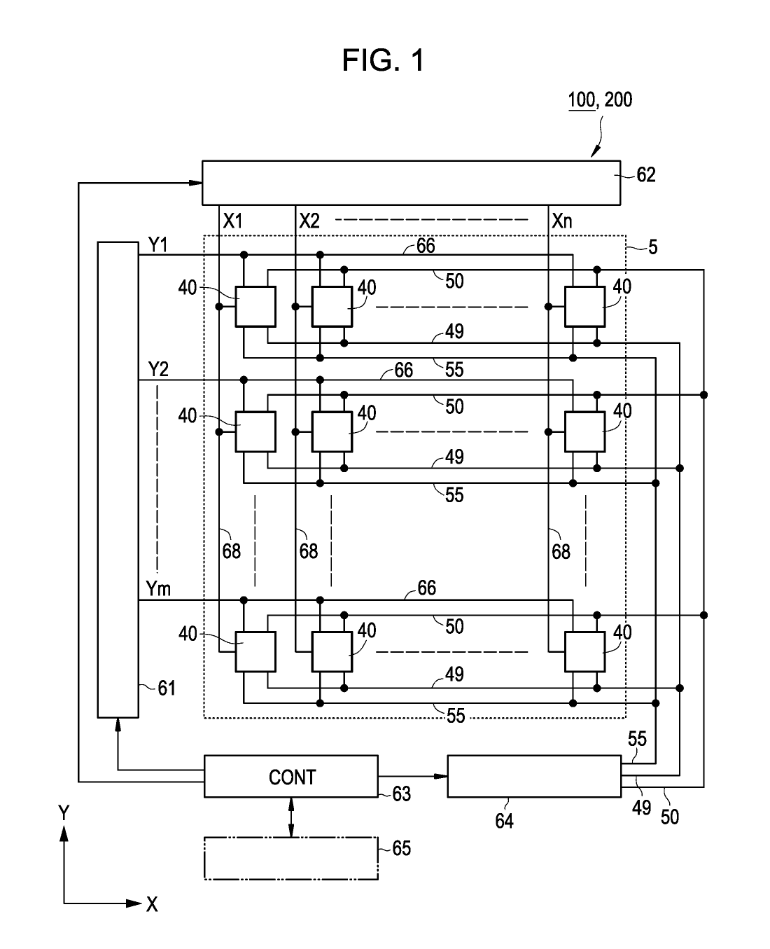

FIG. 1 is a schematic block diagram of an electrophoretic display device 100 according to the present embodiment. The electrophoretic display device 100 includes a display unit 5 in which a plurality of pixels 40 are arranged in a matrix. A scanning line driving circuit 61, a data line driving circuit 62, a controller (control unit) 63 and a common power source modulation circuit 64 are arranged around the display unit 5. The scanning line driving circuit 61, the data line driving circuit 62 and the common power source modulation circuit 64 each are connected to the controller 63. The controller 63 collectively controls those circuits on the basis of image data and synchronization signals supplied from an higher level device.

A plurality of scanning lines 66 that extend from the scanning line driving circuit 61 and a plurality of data lines 68 that extend from the data line driving circuit 62 are formed in the display unit 5. The pixels 40 are provided at positions corresponding to intersections of the plurality of scanning lines 66 and the plurality of data lines 68.

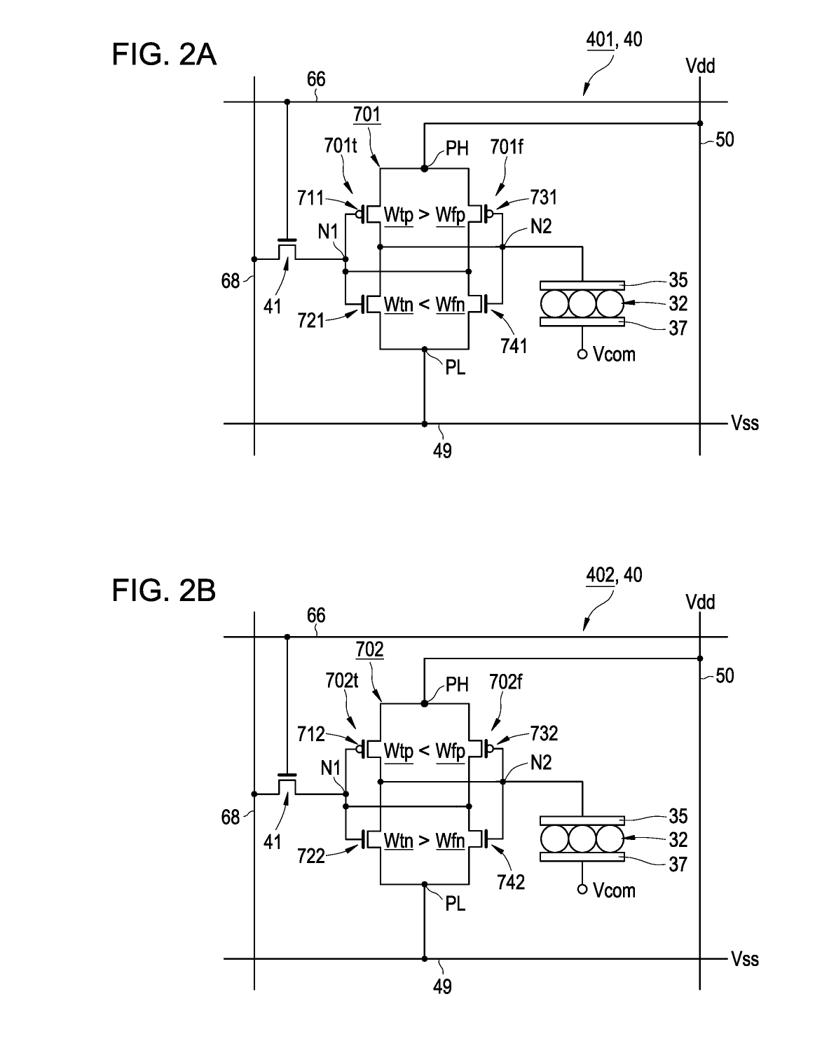

The scanning line driving circuit 61 is connected to each of the pixels 40 through m scanning lines 66 (Y1, Y2, . . . , Ym), sequentially selects the first to mth scanning lines 66 under the control of the controller 63, and supplies a selection signal that specifies an on timing of a driving TFT 41 (see FIG. 2A and FIG. 2B), provided in each pixel 40, through the selected scanning line 66.

The data line driving circuit 62 is connected to each of the pixels 40 through n data lines 68 (X1, X2, Xn) and supplies image signals, each of which specifies one-bit pixel data corresponding to each of the pixels 40, to the pixels 40 under the control of the controller 63. Note that in the present embodiment, when pixel data “0” is specified, a low (L) level image signal is supplied to the pixel 40, whereas when pixel data “1” is specified, a high (H) level image signal is supplied to the pixel 40.

A low-potential power supply line 49, a high-potential power supply line 50 and a common electrode line 55 are provided in the display unit 5 and extend from the common power source modulation circuit 64. Those lines are connected to the pixels 40. The common power source modulation circuit 64, under the control of the controller 63, generates various signals supplied to those lines and electrically connects or disconnects (enter a high impedance state) those lines.

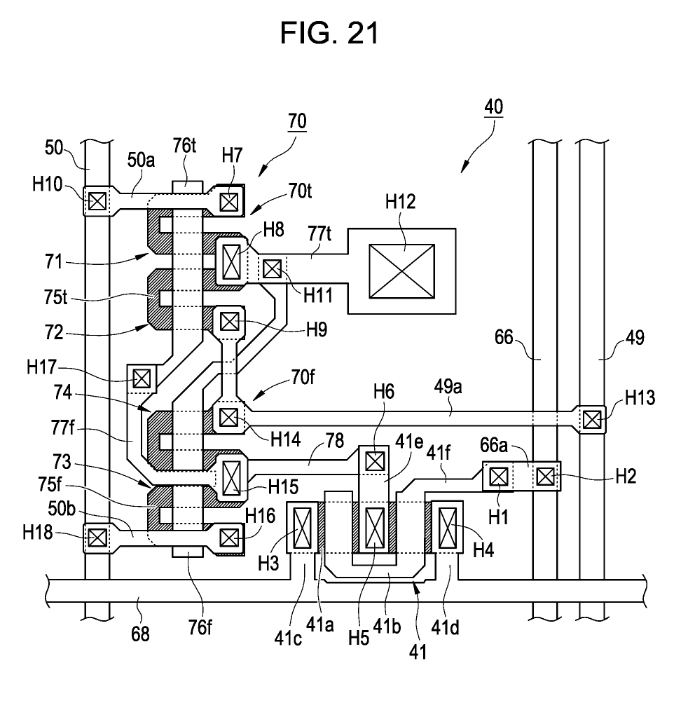

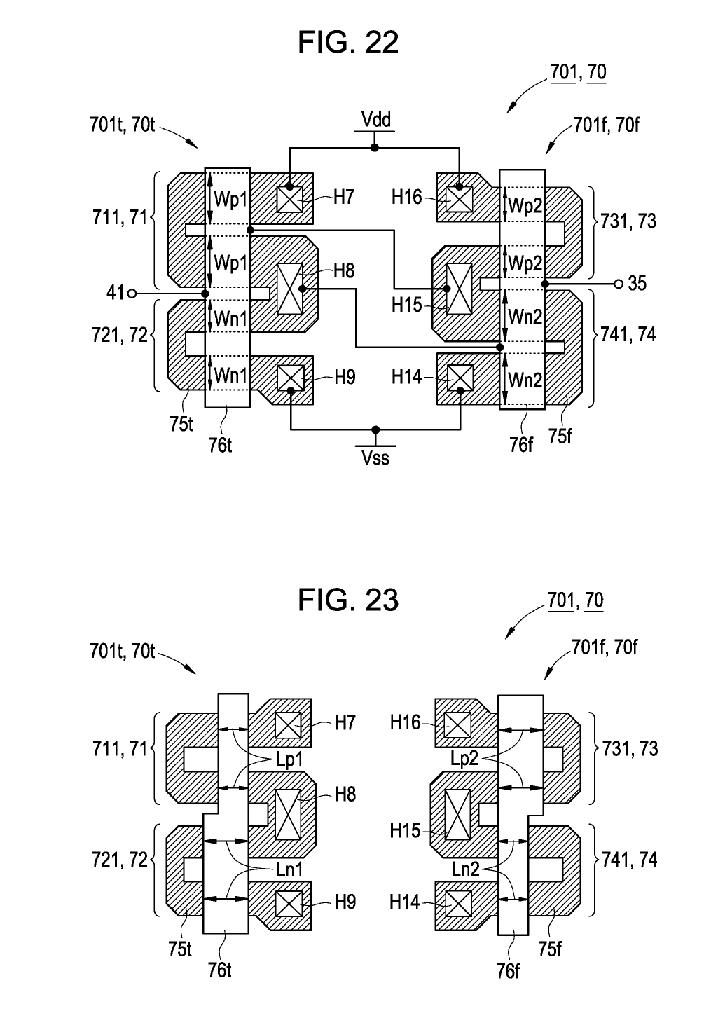

FIG. 2A and FIG. 2B each are a circuit configuration diagram of the pixel 40 provided in the display unit 5. In the electrophoretic display device 100 according to the present embodiment, the display unit 5 is formed by using any one of a first pixel 401 shown in FIG. 2A and a second pixel 402 shown in FIG. 2B or formed by mixedly using both the first pixel 401 and the second pixel 402. Note that in an example embodiment which will be described later, a specific configuration of the first pixel 401 is described in greater detail with reference to FIG. 21 and FIG. 22.

First, as shown in FIG. 2A, the first pixel 401 includes a driving TFT (Thin Film Transistor) 41 (pixel switching element), a latch circuit 701, an electrophoretic element 32, a pixel electrode 35, and a common electrode 37. The scanning line 66, the data line 68, the low-potential power supply line 49 and the high-potential power supply line 50 are arranged so as to surround the above elements. The first pixel 401 is formed in an SRAM (Static Random Access Memory) type such that an image signal is held as an electric potential by the latch circuit 701.

The driving TFT 41 is a pixel switching element formed of an N-MOS (Negative Metal Oxide Semiconductor) transistor. The gate terminal of the driving TFT 41 is connected to the scanning line 66, the source terminal thereof is connected to the data line 68, and the drain terminal is connected to a data input terminal N1 of the latch circuit 701. A data output terminal N2 of the latch circuit 701 is connected to the pixel electrode 35. The electrophoretic element 32 is held between the pixel electrode 35 and the common electrode 37.

The latch circuit 701 includes a transfer inverter 701t and a feedback inverter 701f. The transfer inverter 701t and the feedback inverter 701f each are a C-MOS inverter. The transfer inverter 701t and the feedback inverter 701f form a loop structure such that the input terminals are connected to the output terminals of the other one. These inverters are supplied with a power supply voltage from the high-potential power supply line 50 connected through a high-potential power supply terminal PH and a power supply voltage from the low-potential power supply line 49 connected through a low-potential power supply terminal PL.

The transfer inverter 701t includes a P-MOS (Positive Metal Oxide Semiconductor) transistor 711 and an N-MOS transistor 721. The source terminal of the P-MOS transistor 711 is connected to the high-potential power supply terminal PH, and the drain terminal thereof is connected to the data output terminal N2. The source terminal of the N-MOS transistor 721 is connected to the low-potential power supply terminal PL, and the drain terminal thereof is connected to the data output terminal N2. The gate terminals (input terminal of the transfer inverter 701t) of the P-MOS transistor 711 and N-MOS transistor 721 are connected to the data input terminal N1 (output terminal of the feedback inverter 701f).

The feedback inverter 701f includes a P-MOS transistor 731 and an N-MOS transistor 741. The source terminal of the P-MOS transistor 731 is connected to the high-potential power supply terminal PH, and the drain terminal thereof is connected to the data input terminal N1. The source terminal of the N-MOS transistor 741 is connected to the low-potential power supply terminal PL, and the drain terminal thereof is connected to the data input terminal N1. The gate terminals (input terminal of the feedback inverter 701f) of the P-MOS transistor 731 and N-MOS transistor 741 are connected to the data output terminal N2 (output terminal of the transfer inverter 701t).

In the above configured latch circuit 701, when a high (H) level image signal (pixel data “1”) is latched (stored), a low (L) level signal is output from the data output terminal N2 of the latch circuit 701. On the other hand, when a low (L) level image signal (pixel data “0”) is latched (stored) in the latch circuit 701, a high (H) level signal is output from the data output terminal N2. Then, the electric potential output from the data output terminal N2 is input to the pixel electrode 35. On the other hand, the common electrode 37 is supplied with a common electrode potential Vcom through the common electrode line 55 (FIG. 1). The electrophoretic element 32 displays an image on the basis of an electric field generated by a difference in electric potential between the pixel electrode 35 and the common electrode 37.

In the first pixel 401, the channel widths of the P-MOS transistors of the latch circuit 701 are defined so as to have a predetermined relationship, and the channel widths of the N-MOS transistors of the latch circuit 701 are defined so as to have a predetermined relationship. Specifically, as shown in FIG. 2A, the channel width Wtp of the P-MOS transistor 711 of the transfer inverter 701t is larger than the channel width Wfp of the P-MOS transistor 731 of the feedback inverter 701f, and the channel width Wtn of the N-MOS transistor 721 of the transfer inverter 701t is smaller than the channel width Wfn of the N-MOS transistor 741 of the feedback inverter 701f.

On the other hand, as shown in FIG. 2B, the second pixel 402 includes a latch circuit 702, in place of the latch circuit 701 of the first pixel 401, and the other configuration is the same as that of the first pixel 401. The latch circuit 702 is formed so that a transfer inverter 702t and a feedback inverter 702f, each of which is a C-MOS inverter, are connected in a loop. The transfer inverter 702t includes a P-MOS transistor 712 and an N-MOS transistor 722. The drain terminals of the P-MOS transistor 712 and N-MOS transistor 722 are connected to a data output terminal N2. The feedback inverter 702f includes a P-MOS transistor 732 and an N-MOS transistor 742. The drain terminals of the P-MOS transistor 732 and N-MOS transistor 742 are connected to a data input terminal N1. The latch circuit 702 operates as in the same manner as the latch circuit 701 when an image signal (pixel data) is input to the latch circuit 702.

In the second pixel 402 as well, the channel widths of the P-MOS transistors of the latch circuit 702 are defined so as to have a predetermined relationship, and the channel widths of the N-MOS transistors of the latch circuit 702 are defined so as to have a predetermined relationship. Specifically, as shown in FIG. 2B, the channel width Wtp of the P-MOS transistor 712 of the transfer inverter 702t is smaller than the channel width Wfp of the P-MOS transistor 732 of the feedback inverter 702f, and the channel width Wtn of the N-MOS transistor 722 of the transfer inverter 702t is larger than the channel width Wfn of the N-MOS transistor 742 of the feedback inverter 702f.

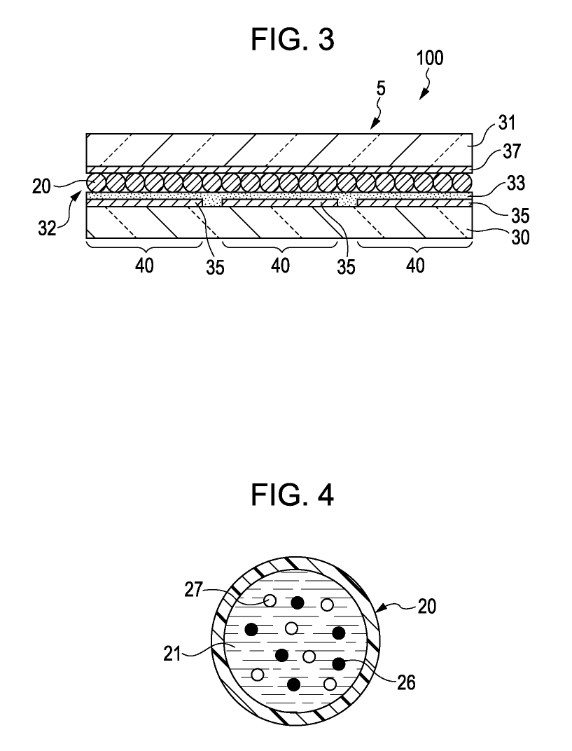

FIG. 3 is a partially cross-sectional view of the electrophoretic display device 100 in the display unit 5. The electrophoretic display device 100 has a configuration such that electrophoretic elements 32 are held between an element substrate 30 and an opposite substrate 31. A plurality of microcapsules 20 are arranged to form the electrophoretic elements 32. In the display unit 5, a plurality of the pixel electrodes 35 are formed and arranged on a side of the element substrate 30 adjacent to the electrophoretic elements 32, and the electrophoretic elements 32 are adhered to the pixel electrodes 35 through an adhesive layer 33. The planar common electrode 37, which faces the plurality of pixel electrodes 35, is formed on a side of the opposite substrate 31 adjacent to the electrophoretic elements 32, and the electrophoretic elements 32 are provided on the common electrode 37.

The element substrate 30 is a substrate made of glass, plastic, or the like, and may be made of an opaque material because the element substrate 30 is arranged on an opposite side with respect to an image display surface. Each pixel electrode 35 is made of Al (aluminum), or the like, and is an electrode that applies a voltage to the electrophoretic element 32. Although not shown in the drawing, the scanning lines 66, the data lines 68, the driving TFTs 41, the latch circuits 701 and 702, and the like, shown in FIG. 1, FIG. 2A, or FIG. 2B, are formed between the pixel electrodes 35 and the element substrate 30.

On the other hand, the opposite substrate 31 is a substrate made of glass, plastic, or the like, and is a transparent substrate because the opposite substrate 31 is arranged on an image display side. The common electrode 37 is an electrode that applies a voltage to the electrophoretic elements 32 together with the pixel electrodes 35, and is a transparent electrode made of MgAg (magnesium silver), ITO (indium tin oxide), IZO (indium zinc oxide), or the like.

Note that the electrophoretic elements 32 are formed on the opposite substrate 31 side in advance, and the electrophoretic sheet generally includes the electrophoretic elements 32, the opposite substrate 31 and the adhesive layer 33. In the manufacturing process, the electrophoretic sheet is handled in a state where a protective release sheet is adhered on the surface of the adhesive layer 33. Then, the display unit 5 is formed in such a manner that the electrophoretic sheet, from which the release sheet has been peeled off, is adhered on the element substrate 30 (on which the pixel electrodes 35 and various circuits are formed) that is separately manufactured. For this reason, the adhesive layer 33 is only present on the side of the pixel electrodes 35.

FIG. 4 is a schematic cross-sectional view of the microcapsule 20. Each microcapsule 20, for example, has a particle size of approximately 50 μm, and is formed in a spherical shape. Each microcapsule 20 incorporates therein a dispersion medium 21, a plurality of white particles (electrophoretic particles) 27 and a plurality of black particles (electrophoretic particles) 26. As shown in FIG. 3, the microcapsules 20 are held between the common electrode 37 and the pixel electrode 35, and one or a plurality of the microcapsules 20 are arranged in each pixel 40.

The outer shell portion (wall film) of each microcapsule 20 is formed of a translucent polymer resin, such as an acrylic resin such as polymethylmethacrylate or polyethylmethacrylate, urea resin, and gum arabic. The dispersion medium 21 is a liquid that disperses the white particles 27 and the black particles 26 within the microcapsule 20. The dispersion medium 21 may include water, alcohol medium such as methanol, ethanol, isopropanol, butanol, octanol, and methyl cellosolve, esters such as ethyl acetate, and butyl acetate, ketones such as acetone, methyl ethyl ketone, and methyl isobutyl ketone, aliphatic hydrocarbon such as pentane, hexane, and octane, alicyclic hydrocarbon such as cyclohexane and methylcyclohexane, aromatic hydrocarbon such as benzene, toluene and benzenes having long-chain alkyl group (such as xylene, hexylbenzene, hebutylbenzene, octylbenzene, nonylbenzene, decylbenzene, undecylbenzene, dodecylbenzene, tridecylbenzene, and tetradecylbenzene), halogenated hydrocarbon such as methylene chloride, chloroform, carbon tetrachloride and 1,2-dichloroethane, carboxylate, and the like, and it may be other oils. These materials may be used either alone or in combination, and may be mixed with a surface-active agent, or the like.

The white particles 27 are, for example, particles (polymer or colloid) formed of white pigment, such as titanium dioxide, zinc white, and antimony trioxide, and are, for example, negatively charged. The black particles 26 are, for example, particles (polymer or colloid) formed of black pigment, such as aniline black, and carbon black, and are, for example, positively charged. These pigments may include additives such as electrolyte, surface active agent, metallic soap, resin, rubber, oil, varnish, charge control agent formed of particles such as compound, and dispersing agent, lubricant, stabilizing agent such as titanium coupling agent, aluminate coupling agent, and silane coupling agent, where necessary. In addition, in place of the black particles 26 and the white particles 27, for example, pigments, such as red color, green color, blue color, and the like, may be used. With the above configuration, red color, green color, blue color, and the like, may be displayed on the display unit 5.

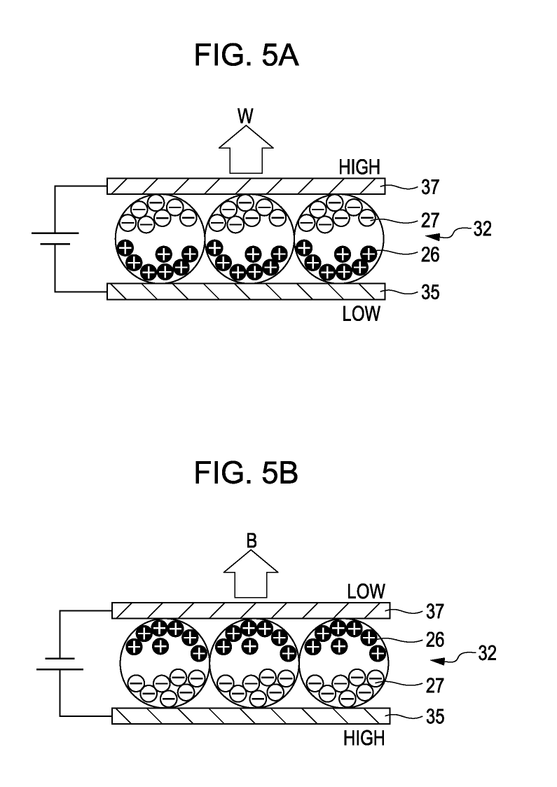

FIG. 5A and FIG. 5B are views illustrating the operation of the electrophoretic element. FIG. 5A shows the case in which the pixel 40 displays white, and FIG. 5B shows the case in which the pixel 40 displays black. In the electrophoretic display device 100, an image signal is input to the data input terminal N1 of each latch circuit 701 or 702 through the driving TFT 41 to thereby make the latch circuit 701 or 702 store the image signal as an electric potential. By so doing, the electric potential corresponding to the image signal is input from the data output terminal N2 of each latch circuit 701 or 702 to the corresponding pixel electrode 35 and, as shown in FIG. 5A and FIG. 5B, the pixel 40 displays black or white on the basis of a difference in electric potential between the pixel electrode 35 and the common electrode 37.

To display white as shown in FIG. 5A, the common electrode 37 is held at a relatively high electric potential, and the pixel electrode 35 is held at a relatively low electric potential. By so doing, the negatively-charged white particles 27 are attracted toward the common electrode 37, while the positively-charged black particles 26 are attracted toward the pixel electrode 35. As a result, when the pixel is viewed from the common electrode 37 side, which is the display surface side, white color (W) is recognized. To display black as shown in FIG. 5B, the common electrode 37 is held at a relatively low electric potential, and the pixel electrode 35 is held at a relatively high electric potential. By so doing, the positively-charged black particles 26 are attracted toward the common electrode 37, while the negatively-charged white particles 27 are attracted toward the pixel electrode 35. As a result, when the pixel is viewed from the common electrode 37 side, black color (B) is recognized.

In the above configured electrophoretic display device 100, each of the first pixels 401 and each of the second pixels 402 that constitute the display unit 5 respectively include the latch circuits 701 and 702 that enter a predetermined initialized state (state in which a predetermined electric potential is held) after power is turned on.

First, the operation of the first pixel 401 after power is turned on will be described. When the latch circuit 701 is supplied with a power supply voltage, the high-potential power supply terminal PH is supplied with an electric potential Vdd of the high-potential power supply line 50, and the low-potential power supply terminal PL is supplied with an electric potential Vss of the low-potential power supply line 49. By so doing, the source terminal of the P-MOS transistor 711 and the source terminal of the P-MOS transistor 731, both of which are connected to the high-potential power supply terminal PH, each attain the electric potential Vdd.

Here, in the present embodiment, as shown in FIG. 2A, the channel width Wtp of the P-MOS transistor 711 is formed so as to be larger than the channel width Wfp of the P-MOS transistor 731. Thus, the P-MOS transistor 711 has a channel resistance smaller than that of the P-MOS transistor 731 and, therefore, the magnitude of electric current that flows through the P-MOS transistor 711 is larger than that flows through the P-MOS transistor 731. Hence, the gate capacitance of the P-MOS transistor 711 is charged for a shorter period of time than the gate capacitance of the P-MOS transistor 731. By so doing, the state of the P-MOS transistor 711 is set prior to the P-MOS transistor 731 (enters an on state).

On the other hand, the source terminal of the N-MOS transistor 721 and the source terminal of the N-MOS transistor 741, both of which are connected to the low-potential power supply terminal PL, each are the electric potential Vss. In the present embodiment, as shown in FIG. 2A, the channel width Wtn of the N-MOS transistor 721 is formed so as to be smaller than the channel width Wfn of the N-MOS transistor 741. Thus, at the low-potential power supply terminal PL side of the latch circuit 701, the gate capacitance of the N-MOS transistor 741 is charged for a shorter period of time than the gate capacitance of the N-MOS transistor 721 and, therefore, the state of the N-MOS transistor 741 is set in first (enters an on state).

As described above, the latch circuit 701, after power is turned on, is stable in a state where the P-MOS transistor 711 of the transfer inverter 701t and the N-MOS transistor 741 of the feedback inverter 701f are turned on. That is, the latch circuit 701 is stable in a state where the data input terminal N1 is at a low level, and in a state similar to the state in which a low level image signal (pixel data “0”) is written through the driving TFT 41.

Next, the operation of the second pixel 402 after power is turned on will be described. In the latch circuit 702 of the second pixel 402, when power is turned on, the source terminal of the P-MOS transistor 712 and the source terminal of the P-MOS transistor 732, both of which are connected to the high-potential power supply terminal PH, each attain the electric potential Vdd. Then, as shown in FIG. 2B, the channel width Wtp of the P-MOS transistor 712 is smaller than the channel width Wfp of the P-MOS transistor 732, the gate capacitance of the P-MOS transistor 732 is charged for a shorter period of time than the gate capacitance of the P-MOS transistor 712. By so doing, the state of the P-MOS transistor 732 is set prior to the P-MOS transistor 712 (enters an on state).

On the other hand, the source terminal of the N-MOS transistor 722 and the source terminal of the N-MOS transistor 742, both of which are connected to the low-potential power supply terminal PL, each attain the electric potential Vss. Then, as shown in FIG. 2B, the channel width Wtn of the N-MOS transistor 722 is larger than the channel width Wfn of the N-MOS transistor 742 and, therefore, at the low-potential power supply terminal PL side of the latch circuit 702, the gate capacitance of the N-MOS transistor 722 is charged for a shorter period of time than the N-MOS transistor 742. By so doing, the state of the N-MOS transistor 722 is set prior to the N-MOS transistor 742 (enters an on state).

As described above, the latch circuit 702, after power is turned on, is stable in a state where the N-MOS transistor 722 of the transfer inverter 702t and the P-MOS transistor 732 of the feedback inverter 702f are turned on. That is, the latch circuit 702 is stable in a state where the data input terminal N1 is at a high level, and in a state similar to the state in which a high level image signal (pixel data “1”) is written through the driving TFT 41. Note that the description is made on the assumption that the configuration other than the channel width of each transistor is the same except manufacturing variations.

In this way, the first and second pixels 401 and 402 provided for the electrophoretic display device 100 of the present embodiment are definitely stable in a state where a predetermined electric potential (image signal) is held at the time when power is turned on. Thus, when the first pixels 401 and/or the second pixels 402 are arranged at specific positions of the display unit 5, it is possible to form the initialized state, similar to the state in which predetermined image data are written, on the display unit 5 by turning on power. Then, in the display unit 5 of the initialized state, when the electric potential is input to the common electrode 37 to drive the electrophoretic elements 32, it is possible to display an image based on the arrangement of the first pixels 401 and the second pixel 402 on the display unit 5.

Thus, according to the electrophoretic display device 100 of the present embodiment, when only the specific pixels 40, for example, employ the first pixel 401 and the other pixels 40 employ the second pixel 402, it is possible to display a predetermined image (logo, or the like) when power is turned on or display an alarm image when a predetermined condition is satisfied. Furthermore, when the entire display unit 5 is formed of the first pixels 401 or the second pixels 402, it is possible to display black or white all over the display unit. Thus, it is possible to execute the same operation as an image deletion operation. Note that a specific example of a driving method using the initialized state will be described in greater detail later.

### First Alternative Example of First Embodiment

In addition, in the above embodiment, in order to set the content of memory of the latch circuit at the time of initialization, the channel width of the transistor is utilized; it is applicable that another configuration that is able to similarly vary a channel resistance is employed. Specifically, in FIG. 2A, the channel length of the P-MOS transistor 711 is formed so as to be shorter than the channel length of the P-MOS transistor 731. By so doing, the P-MOS transistor 711 has a channel resistance smaller than that of the P-MOS transistor 731, and the magnitude of electric current that flows through the P-MOS transistor 711 is larger than that flows through the P-MOS transistor 731. Hence, the gate capacitance of the P-MOS transistor 711 is charged for a shorter period of time than the gate capacitance of the P-MOS transistor 731. By so doing, the state of the P-MOS transistor 711 is set prior to the P-MOS transistor 731 (enters an on state). In addition, the channel length of the N-MOS transistor 721 is formed so as to be longer than the channel length of the N-MOS transistor 741. By so doing, because the gate capacitance of the N-MOS transistor 741 is charged for a shorter period of time than the gate capacitance of the N-MOS transistor 721, the state of the N-MOS transistor 741 is set prior to the N-MOS transistor 721. In this manner, the latch circuit 701 may be stably held at a predetermined electric potential.

Similarly, as shown in FIG. 2B, the channel length of the P-MOS transistor 712 is formed so as to be longer than the channel length of the P-MOS transistor 732, while the channel length of the N-MOS transistor 722 is formed so as to be shorter than the channel length of the N-MOS transistor 742. By so doing, as in the similar manner to the latch circuit 701, the latch circuit 702 may be stably held at a predetermined electric potential. Thus, even with this configuration as well, it is possible to obtain similar function and advantageous effects to those of the above embodiment. Note that the description is made on the assumption that the configuration other than the channel length of each transistor is the same. In addition, a specific transistor structure, and the like, of this configuration will be described in greater detail in an example embodiment which will be described later with reference to FIG. 21 and FIG. 23.

### Second Alternative Example of First Embodiment

Furthermore, in order to set the content of memory of the latch circuit at the time of initialization, the number of gates (number of channels) of each of the P-MOS transistors that constitute the latch circuit may be varied.

Specifically, in FIG. 2A, the P-MOS transistor 711 of the transfer inverter 701t is, for example, formed to have a double gate structure, and the P-MOS transistor 731 of the feedback inverter 701f is, for example, formed to have a triple gate structure. Thus, the P-MOS transistor 711 has a channel resistance smaller than that of the P-MOS transistor 731 and, therefore, the magnitude of electric current that flows through the P-MOS transistor 711 is larger than that flows through the P-MOS transistor 731. Hence, the gate capacitance of the P-MOS transistor 711 is charged for a shorter period of time than the gate capacitance of the P-MOS transistor 731. By so doing, the state of the P-MOS transistor 711 is set prior to the P-MOS transistor 731 (enters an on state).

In addition, the N-MOS transistor 721 is formed to have a triple gate structure, while the N-MOS transistor 741 is formed to have a double gate structure. By so doing, because the gate capacitance of the N-MOS transistor 741 is charged for a shorter period of time than the gate capacitance of the N-MOS transistor 721, the state of the N-MOS transistor 741 is set prior to the N-MOS transistor 721. In this manner, the latch circuit 701 of the first pixel 401 may be stably held at a predetermined electric potential.

Similarly, in FIG. 2B, the P-MOS transistor 712 is, for example, formed to have a triple gate structure, and the P-MOS transistor 732 is, for example, formed to have a double gate structure. In addition, the N-MOS transistor 722 is, for example, formed to have a double gate structure, and the N-MOS transistor 742 is, for example, formed to have a triple gate structure. By so doing, as in the similar manner to the latch circuit 701, the latch circuit 702 of the second pixel 402 may be stably held at a predetermined electric potential. Thus, even with this configuration as well, it is possible to obtain similar function and advantageous effects to those of the above embodiment.

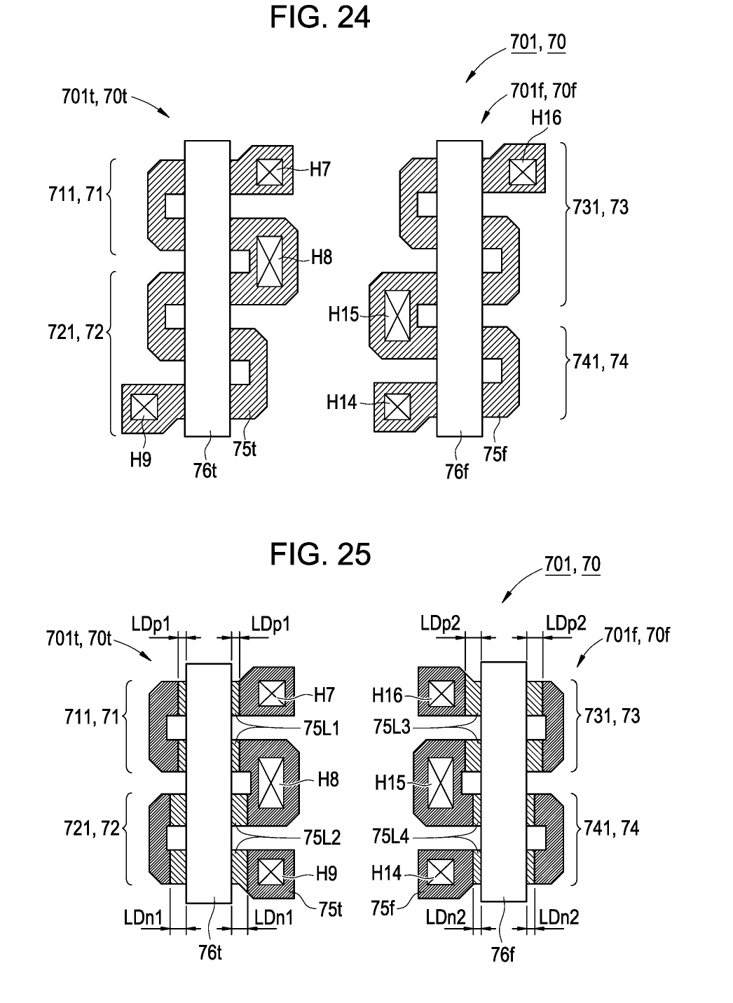

Note that the description is made on the assumption that the configuration other than the number of gates of each transistor is the same. In addition, the number of gates of each transistor is not limited to a double gate structure or a triple gate structure. As long as the relationship in the number of gates satisfies the above relationship, a single gate structure or multi-gate structure having four or more gates may be employed. In addition, a specific transistor structure, and the like, of this configuration will be described in greater detail in an example embodiment which will be described later with reference to FIG. 21 and FIG. 24.

### Third Alternative Example of First Embodiment

Yet furthermore, in order to set the content of memory of the latch circuit at the time of initialization, the LDD (Lightly Doped Drain) structure of the transistor that constitutes the latch circuit may be utilized. In this configuration, in FIG. 2A, an LDD region, which is a low concentration impurity region, is formed between a channel region and source/drain region of each transistor that constitutes the latch circuit.

Then, the LDD length (the length of the LDD region in a direction in which a carrier moves) of the P-MOS transistor 711 is formed so as to be smaller (shorter) than the LDD length of the P-MOS transistor 731. Thus, the P-MOS transistor 711 has a smaller resistance of the LDD region than the P-MOS transistor 731 and, therefore, the magnitude of electric current that flows through the P-MOS transistor 711 is larger than that flows through the P-MOS transistor 731. Hence, the gate capacitance of the P-MOS transistor 711 is charged for a shorter period of time than the gate capacitance of the P-MOS transistor 731. By so doing, the state of the P-MOS transistor 711 is set prior to the P-MOS transistor 731 (enters an on state).

In addition, the LDD length of the N-MOS transistor 721 is formed so as to be larger (longer) than the LDD length of the N-MOS transistor 741. By so doing, because the gate capacitance of the N-MOS transistor 741 is charged for a shorter period of time than the gate capacitance of the N-MOS transistor 721, the state of the N-MOS transistor 741 is set prior to the N-MOS transistor 721. In this manner, the latch circuit 701 of the first pixel 401 may be stably held at a predetermined electric potential.

Similarly, as shown in FIG. 2B, the LDD length of the P-MOS transistor 712 is formed so as to be larger (longer) than the LDD length of the P-MOS transistor 732, while the LDD length of the N-MOS transistor 722 is formed so as to be smaller (shorter) than the LDD length of the N-MOS transistor 742. By so doing, as in the similar manner to the latch circuit 701, the latch circuit 702 of the second pixel 402 may be stably held at a predetermined electric potential. Thus, even with this configuration as well, it is possible to obtain similar function and advantageous effects to those of the above embodiment. Note that the description is made on the assumption that the configuration other than the LDD length of each transistor is the same. In addition, a specific transistor structure, and the like, of this configuration will be described in greater detail in an example embodiment which will be described later with reference to FIG. 21 and FIG. 25.

### Fifth Alternative Example of First Embodiment

In the above described first embodiment and its alternative examples, the configurations for adjusting gate capacitance charging time of the transistor are respectively described. The configurations for adjusting the gate capacitance charging time may be combined. For example, the configuration for adjusting gate capacitance charging time by means of the channel width according to the first embodiment and the configuration for adjusting gate capacitance charging time by means of the channel length according to the first alternative example may be combined.

That is, the channel width of the P-MOS transistor 711 of the transfer inverter 701t is formed so as to be larger than the channel width of the P-MOS transistor 731 of the feedback inverter 701f, and the channel length of the P-MOS transistor 711 is formed so as to be smaller than the channel length of the P-MOS transistor 731.

In addition, the channel width of the N-MOS transistor 721 of the transfer inverter 701t is formed so as to be smaller than the channel width of the N-MOS transistor 742 of the feedback inverter 701f, and the channel length of the N-MOS transistor 721 is larger than the channel length of the N-MOS transistor 742. Even when the configurations according to the first embodiment and the alternative embodiments are combined as well, it is possible to obtain similar function and advantageous effects to those of the above embodiment.

### Sixth Alternative Example of First Embodiment

Furthermore, in the case in which the first embodiment is combined with the configuration of the alternative example thereof, a combination by which the function of extending or reducing the gate capacitance charging time is opposite may be employed.

For example, when the configuration for adjusting the gate capacitance charging time by means of the channel width according to the first embodiment is combined with the configuration for adjusting the gate capacitance charging time by means of the channel length according to the first alternative example, the channel width of the P-MOS transistor 711 of the transfer inverter 701t is formed so as to be larger than the channel width of the P-MOS transistor 731 of the feedback inverter 701f, while the channel length of the P-MOS transistor 711 is formed so as to be larger than the channel length of the P-MOS transistor 731.

In addition, the channel width of the N-MOS transistor 721 of the transfer inverter 701t is formed so as to be smaller than the channel width of the N-MOS transistor 742 of the feedback inverter 701f, while the channel length of the N-MOS transistor 721 is formed so as to be smaller than the channel length of the N-MOS transistor 742.

In the case as configured above, the function of adjusting the gate capacitance charging time by varying the channel length cancels the function of adjusting the gate capacitance charging time by varying the channel width. Then, it is possible to minutely adjust the gate capacitance charging time by varying, for example, the gate length. Therefore, it is possible to further accurately adjust the gate capacitance charging time with further high precision. Hence, according to the present alternative example, it is possible to further stably obtain the function and advantageous effects of the above embodiment.

### Second Embodiment

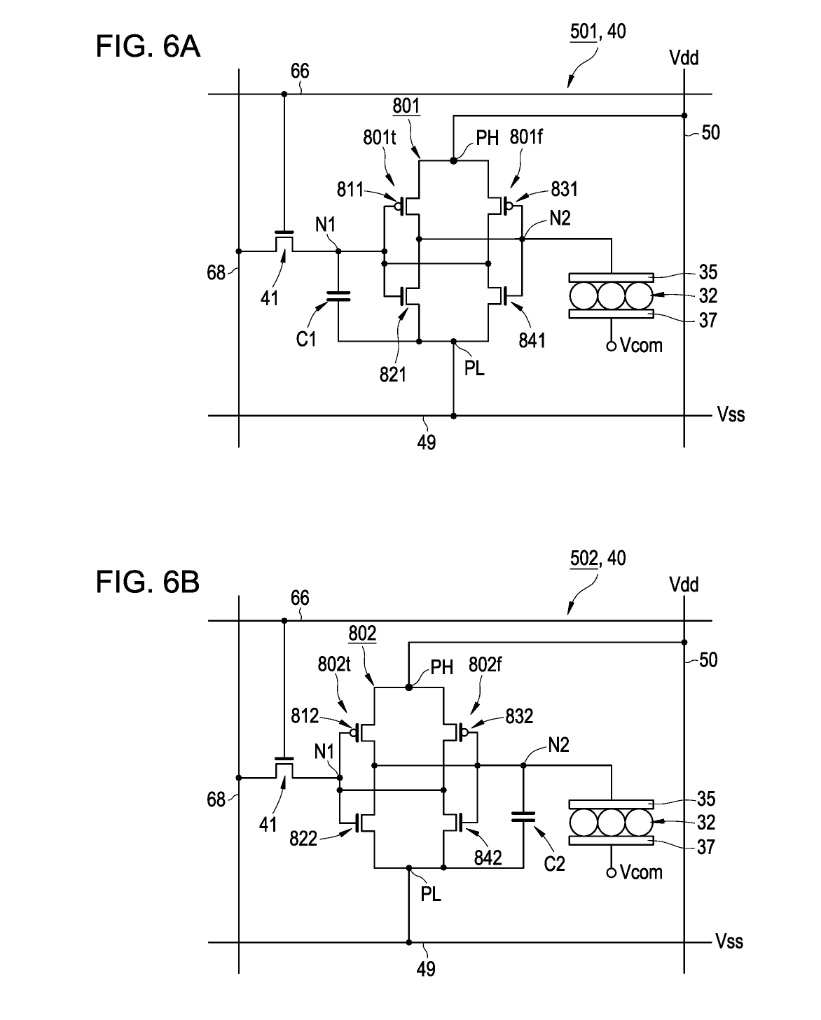

Next, a second embodiment of the invention will be described with reference to FIG. 6A and FIG. 6B. An electrophoretic display device 200 according to the present embodiment has a similar basic configuration as that of the electrophoretic display device 100 according to the first embodiment shown in FIG. 1. The second embodiment differs from the first embodiment in that the electrophoretic display device 200 employs a first pixel 501 shown in FIG. 6A and a second pixel 502 shown in FIG. 6B as first and second pixels that may be applied to the pixels 40 that constitute the display unit 5. Thus, in the following description, the first and second pixels 501 and 502 will be described in detail, and the description of the similar components to those of the first embodiment is omitted where appropriate. In addition, in FIG. 6A and FIG. 6B, like reference numerals denote like components to those of FIG. 2A and FIG. 2B, and the detailed description thereof is omitted.

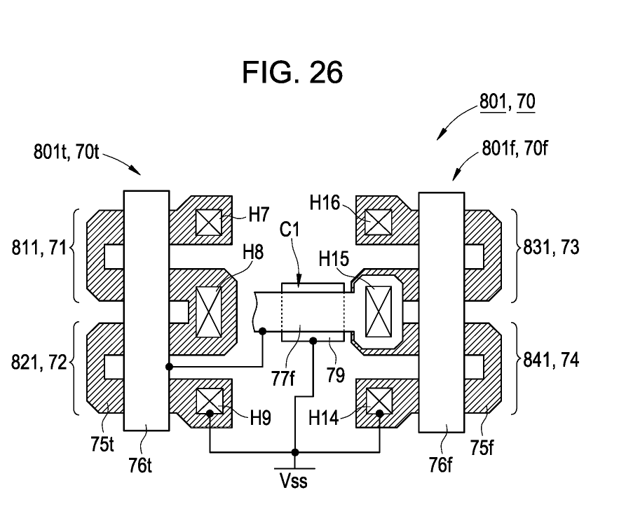

As shown in FIG. 6A, the first pixel 501 includes a driving TFT 41, which serves as a pixel switching element, a latch circuit 801, a pixel electrode 35, an electrophoretic element 32, and a common electrode 37. The latch circuit 801 is formed so that a transfer inverter 801t and a feedback inverter 801f are connected in a loop. Note that in an example embodiment which will be described later, a specific configuration of the first pixel 501 is described in greater detail with reference to FIG. 21 and FIG. 26.

The transfer inverter 801t includes a P-MOS transistor 811, an N-MOS transistor 821, and a capacitor C1. The source terminal of the P-MOS transistor 811 is connected to the high-potential power supply terminal PH, and the drain terminal thereof is connected to the data output terminal N2. The source terminal of the N-MOS transistor 821 is connected to the low-potential power supply terminal PL, and the drain terminal thereof is connected to the data output terminal N2. The gate terminals of the P-MOS transistor 811 and the N-MOS transistor 821 both are connected to the data input terminal N1. One of the electrodes of the capacitor C1 is connected to the data input terminal N1 (input terminal of the transfer inverter 801t), and the other one of the electrodes is connected to the low-potential power supply terminal PL (source terminal of the N-MOS transistor 821).

The feedback inverter 801f includes a P-MOS transistor 831 and an N-MOS transistor 841. The source terminal of the P-MOS transistor 831 is connected to the high-potential power supply terminal PH, and the drain terminal thereof is connected to the data input terminal N1. The source terminal of the N-MOS transistor 841 is connected to the low-potential power supply terminal PL, and the drain terminal thereof is connected to the data input terminal N1. The gate terminals of the P-MOS transistor 831 and N-MOS transistor 841 both are connected to the data output terminal N2.

The first pixel 501 operates as in the same manner as the first pixel 401 according to the first embodiment. When the latch circuit 801 of the first pixel 501 is supplied with a power supply voltage, the source terminal of the P-MOS transistor 811 and the source terminal of the P-MOS transistor 831, both of which are connected to the high-potential power supply terminal PH, each attain the electric potential Vdd. In addition, the source terminal of the N-MOS transistor 821 and the source terminal of the N-MOS transistor 841, both of which are connected to the low-potential power supply terminal PL, each attain the electric potential Vss.

Here, in the present embodiment, as shown in FIG. 6A, the capacitor C1 provided for the latch circuit 801 is connected in parallel with the gate capacitance of the N-MOS transistor 821. Thus, when the gate capacitance of each transistor is charged with a power supply voltage supplied to the latch circuit 801, charging of the gate capacitance of the N-MOS transistor 821 is delayed. Then, charging of the gate capacitance of the N-MOS transistor 841 and charging of the gate capacitance of the P-MOS transistor 811 end before charging of the gate capacitance of the N-MOS transistor 821. By so doing, the state of the P-MOS transistor 811 and the state of the N-MOS transistor 841 are set prior to the N-MOS transistor 821 (enter an on state).

As described above, the latch circuit 801, after power is turned on, is stable in a state where the P-MOS transistor 811 of the transfer inverter 801t and the N-MOS transistor 841 of the feedback inverter 801f are turned on. That is, the latch circuit 801 is stable in a state where the data input terminal N1 is at a low level, and in a state similar to the state in which a low level image signal (pixel data “0”) is written through the driving TFT 41.

Next, as shown in FIG. 6B, the second pixel 502 includes a driving TFT 41, a latch circuit 802, a pixel electrode 35, an electrophoretic element 32, and a common electrode 37. The latch circuit 802 is formed so that a transfer inverter 802t and a feedback inverter 802f are connected in a loop.

The transfer inverter 802t includes a P-MOS transistor 812 and an N-MOS transistor 822. The source terminal of the P-MOS transistor 812 is connected to the high-potential power supply terminal PH, and the source terminal of the N-MOS transistor 822 is connected to the low-potential power supply terminal PL. The drain terminals of the P-MOS transistor 812 and N-MOS transistor 822 both are connected to the data output terminal N2, and the gate terminals thereof both are connected to the data input terminal N1.

The feedback inverter 802f includes a P-MOS transistor 832, an N-MOS transistor 842, and a capacitor C2. The source terminal of the P-MOS transistor 832 is connected to the high-potential power supply terminal PH, and the source terminal of the N-MOS transistor 842 is connected to the low-potential power supply terminal PL. The drain terminals of the P-MOS transistor 832 and N-MOS transistor 842 both are connected to the data input terminal N1, and the gate terminals thereof both are connected to the data output terminal N2. One of the electrodes of the capacitor C2 is connected to the data output terminal N2 (input terminal of the feedback inverter 802f), and the other one of the electrodes is connected to the low-potential power supply terminal PL (source terminal of the N-MOS transistor 842).

The second pixel 502 operates as in the same manner as the second pixel 402 according to the first embodiment. When the latch circuit 802 of the second pixel 502 is supplied with a power supply voltage, the source terminal of the P-MOS transistor 812 and the source terminal of the P-MOS transistor 832, both of which are connected to the high-potential power supply terminal PH, each attain the electric potential Vdd. In addition, the source terminal of the N-MOS transistor 822 and the source terminal of the N-MOS transistor 842, both of which are connected to the low-potential power supply terminal PL, each are the electric potential Vss.

Here, in the present embodiment, as shown in FIG. 6B, the capacitor C2 provided for the latch circuit 802 is connected in parallel with the gate capacitance of the N-MOS transistor 842. Thus, when the gate capacitance of each transistor is charged with a power supply voltage supplied to the latch circuit 802, charging of the gate capacitance of the N-MOS transistor 842 is delayed. Then, charging of the gate capacitance of the N-MOS transistor 822 and charging of the gate capacitance of the P-MOS transistor 832 end before charging of the gate capacitance of the N-MOS transistor 842. By so doing, the state of the P-MOS transistor 832 and the state of the N-MOS transistor 822 are set prior to the N-MOS transistor 842 (enter an on state). Note that the above description is made on the assumption that characteristics, such as a switching frequency in each transistor, are the same except manufacturing variations.

As described above, the latch circuit 802, after power is turned on, is stable in a state where the N-MOS transistor 822 of the transfer inverter 802t and the P-MOS transistor 832 of the feedback inverter 802f are turned on. That is, the latch circuit 802 is stable in a state where the data input terminal N1 is at a high level, and in a state similar to the state in which a high level image signal (pixel data “1”) is written through the driving TFT 41.

As described in detail above, the first pixel 501 and the second pixel 502, as well as the first pixel 401 and the second pixel 402 according to the first embodiment, are definitely stable in a state where a predetermined electric potential (image signal) is held at the time when power is turned on. Thus, when the first pixels 501 and/or the second pixels 502 are arranged at specific positions of the display unit 5, it is possible to form the initialized state, similar to the state in which predetermined image data are written, on the display unit 5 by turning on power. Then, in the display unit 5 of the initialized state, when the electric potential is input to the common electrode 37, it is possible to display an image based on the arrangement of the first pixels 501 and the second pixel 502 on the display unit 5.

Then, according to the electrophoretic display device 200 of the present embodiment, when only the specific pixels 40 are, for example, employ the first pixel 501 and the other pixels 40 employ the second pixel 502, it is possible to display a predetermined image (logo, or the like) when power is turned on or display an alarm image when a predetermined condition is satisfied. Furthermore, when the entire display unit 5 is formed of the first pixels 501 or the second pixels 502, it is possible to display black or white all over the display unit. Thus, it is possible to execute the same operation as an image deletion operation. Note that a specific example of a driving method using the initialized state will be described in greater detail later.

Note that the first and second pixels 401 and 402 constitute the display unit 5 in the above described first embodiment, and the first and second pixels 501 and 502 constitute the display unit 5 in the second embodiment; instead, the display unit 5 may be constituted of the first pixels 401 according to the first embodiment and the second pixels 502 according to the second embodiment. Alternatively, a combination of the second pixels 402 according to the first embodiment and the first pixels 501 according to the second embodiment may also be used.

In addition, in the second embodiment, the capacitors C1 and C2 are connected to the low-potential power supply terminal PL; instead, it may be connected to the high-potential power supply terminal PH. In this case, in FIG. 6A, the capacitor C1 is connected between the data input terminal N1 and the high-potential power supply terminal PH. By so doing, the capacitor C1 is connected in parallel with the gate capacitance of the P-MOS transistor 811 and, therefore, charging of the gate capacitance of that transistor is delayed. Thus, the state of the P-MOS transistor 831 and the state of the N-MOS transistor 821 are set in first (enter an on state).

Similarly, in FIG. 6B, the capacitor C2 is connected between the data output terminal N2 and the high-potential power supply terminal PH. By so doing, the capacitor C2 is connected in parallel with the gate capacitance of the P-MOS transistor 832 and, therefore, charging of the gate capacitance of that transistor is delayed. Thus, the state of the P-MOS transistor 812 and the state of the N-MOS transistor 842 are set in first (enter an on state). even with this configuration as well, it is possible to obtain similar function and advantageous effects to those of the above embodiment.

### Alternative Example of Second Embodiment

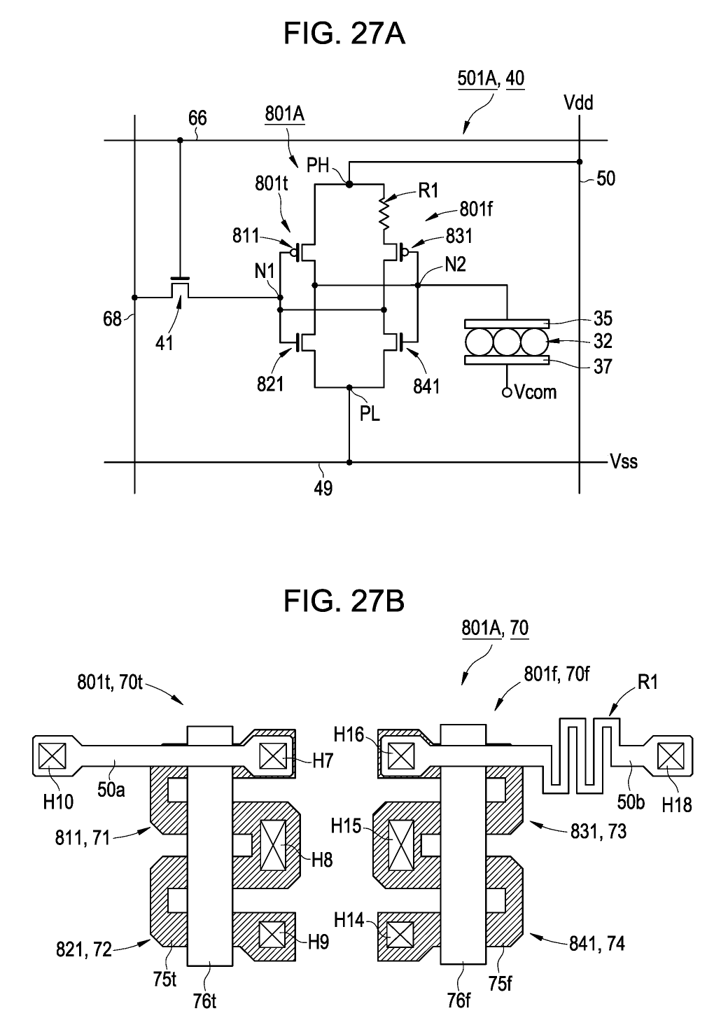

In addition, in the above embodiment, in order to set the content of memory of the latch circuit at the time of initialization, the capacitor is added; instead, it is applicable that another configuration that is able to similarly vary charging time of the gate capacitance is employed. Specifically, in FIG. 6A, a configuration, in which not the capacitor C1 but a resistance element is added, may be employed. FIG. 27A shows a circuit diagram of a first pixel 501A that includes a latch circuit 801A having a resistance element R1.

In FIG. 6A, the capacitor C1 is connected between the data input terminal N1 of the latch circuit 801 and the low-potential power supply terminal PL, while in the first pixel 501A shown in FIG. 27A, a resistance element R1 is interposed between the source terminal of the P-MOS transistor 831 of the latch circuit 801A and the high-potential power supply terminal PH.

According to the above configuration, owing to the function of the resistance element R1, an electric current that flows from the high-potential power supply terminal PH to the P-MOS transistor 831 is smaller in magnitude than an electric current that flows from the high-potential power supply terminal PH to the P-MOS transistor 811. By so doing, the gate capacitance of the P-MOS transistor 811 is charged for a shorter period of time than the gate capacitance of the P-MOS transistor 831. Thus, the state of the P-MOS transistor 811 is set prior to the P-MOS transistor 831 (enters an on state).

Similarly, in the configuration corresponding to the second pixel shown in FIG. 6B, in place of the resistance element R1 shown in FIG. 27A, a resistance element is connected between the source terminal of the P-MOS transistor 811 and the high-potential power supply terminal PH. With the above configuration, an electric current that flows from the high-potential power supply terminal PH to the P-MOS transistor 811 is smaller in magnitude than an electric current that flows from the high-potential power supply terminal PH to the P-MOS transistor 831. Thus, the state of the P-MOS transistor 831 is set prior to the P-MOS transistor 811. Hence, it is possible to obtain similar function and advantageous effects to those of the above embodiment. Note that the description is made on the assumption that the configuration other than the resistance element in each transistor is the same. In addition, a specific transistor structure, a wiring structure, and the like, of this configuration will be described in greater detail in an example embodiment which will be described later with reference to FIG. 21 and FIG. 27B.

### Driving Method

Next, methods of driving the electrophoretic display devices 100 and 200 according to the above described first and second embodiments will be described in detail with reference to the accompanying drawings. As described above, the electrophoretic display devices 100 and 200 and the electrophoretic display devices according to the alternative examples have equivalent functions. Thus, in the following description of the driving method, only the method of driving the electrophoretic display device 100 according to the first embodiment will be described.

### First Driving Method (Image Display Utilizing Initialized State)

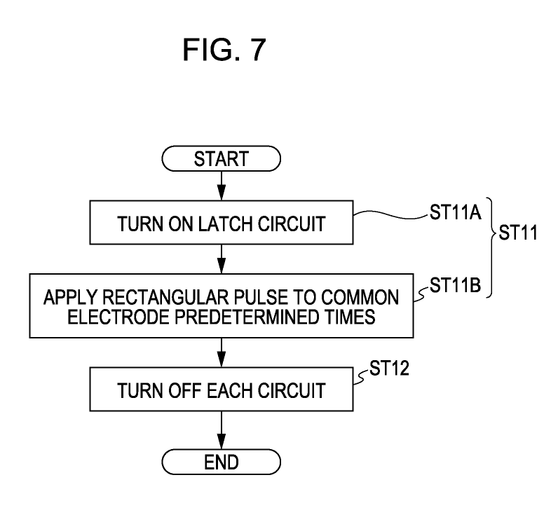

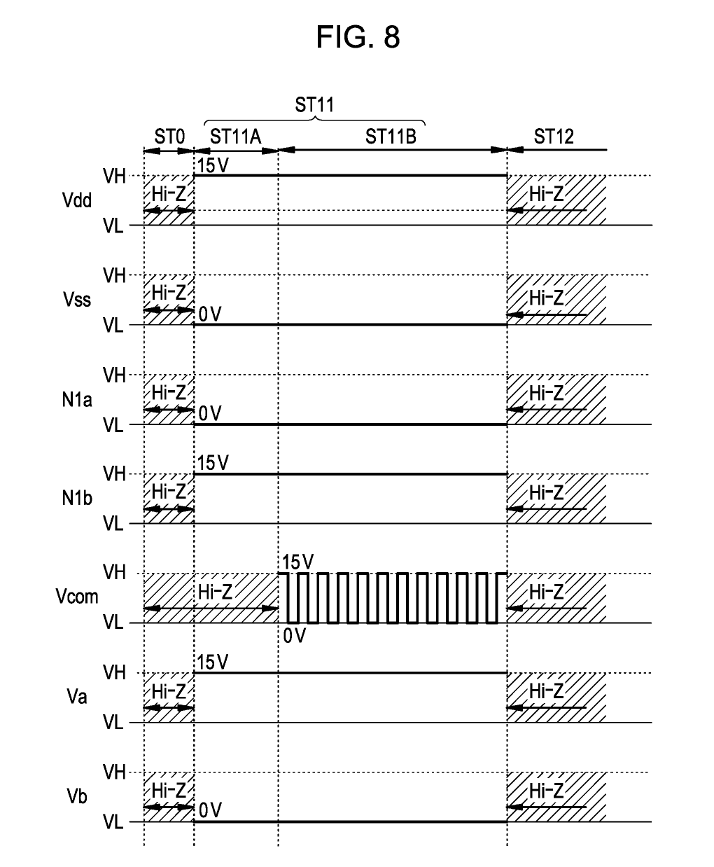

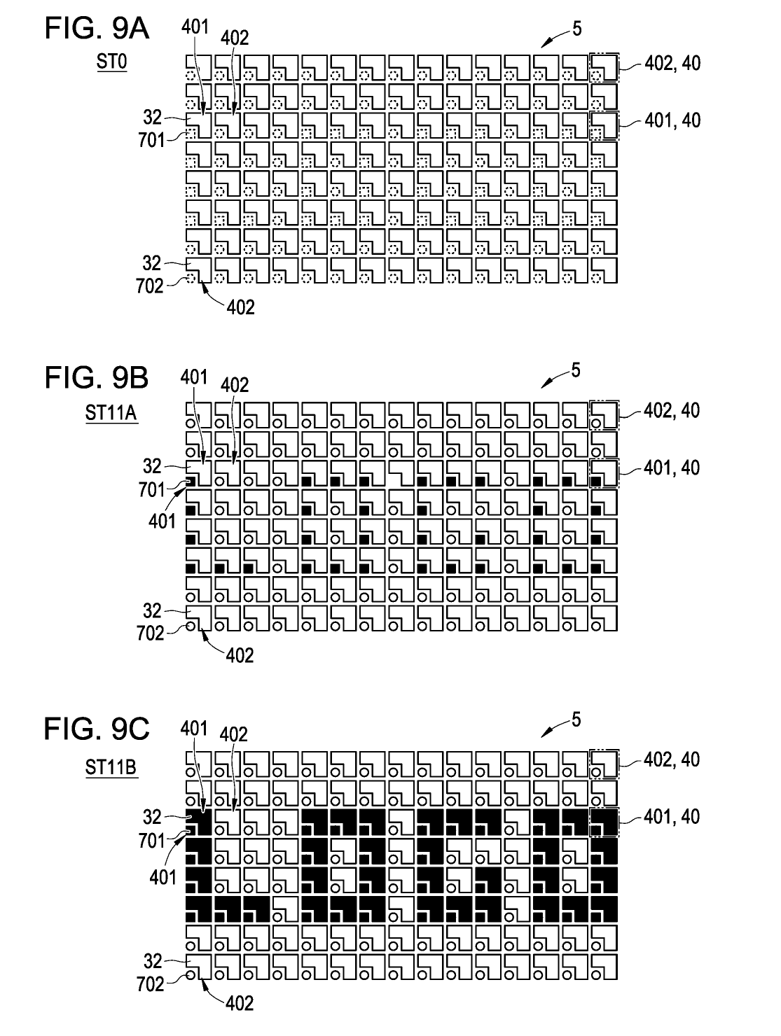

First, an example in which an image is displayed utilizing an initialized state will be described with reference to FIG. 7 to FIG. 9C. FIG. 7 is a view that shows a flowchart according to a first driving method. FIG. 8 is a timing chart including steps shown in FIG. 7. FIG. 9A to FIG. 9C are views that show changes in state of the display unit 5 in accordance with the first driving method.

The first driving method constitutes portion of a start-up sequence of the electrophoretic display device 100 and, more specifically, executes an operation by which a logo image that is formed in the display unit 5 in advance is displayed at the time when the electrophoretic display device 100 starts up.

First, as shown in FIG. 9A to FIG. 9C, in the display unit 5 of the electrophoretic display device to which the first driving method is applied, the pixels 40 formed of the first pixel 401 and the pixels 40 formed of the second pixel 402 are mixed, and are arranged so as to form a specific logo image by the first and second pixels 401 and 402. Note that the display units 5 shown in FIG. 9A to FIG. 9C just illustrate the arrangements of the first and second pixels 401 and 402.

In FIG. 9A to FIG. 9C, each of the first pixels 401 is shown by the latch circuit 701 indicated by a rectangular symbol and the electrophoretic element 32 indicated by an inverted L-shaped symbol. In addition, each of the second pixels 402 is shown by the latch circuit 702 indicated by a circular symbol and the electrophoretic element 32 indicated by an inverted L-shaped symbol. Then, as shown in FIG. 9C, the first pixels 401 shown as solid pixels are arranged so as to form a logo image “LOGO” in black characters on the display unit 5, and the second pixels 402 shown as outline pixels are arranged as background in the region other than the first pixels 401.

As shown in FIG. 7, the first driving method includes an initial image display step ST11 and a turn-off step ST12. The initial image display step ST11 (initial image display period) includes a memory initialization step ST11A in which the latch circuits 701 and 702 are turned on to initialize the latch circuits 701 and 702 and an image display step ST11B in which a predetermined pulse is input to the common electrode 37 to display an initial image that is formed in the display unit 5 in advance.

FIG. 8 shows a timing chart according to a series of operations including the initial image display step ST11. In addition, FIG. 8 shows electric potentials of terminals and electrodes in each of the first pixels 401 and the second pixels 402 shown in FIG. 9A to FIG. 9C. That is, FIG. 8 shows an electric potential Vdd of the high-potential power supply line 50 (high-potential power supply terminal PH), an electric potential Vss of the low-potential power supply line 49 (low-potential power supply terminal PL), an electric potential N1a of the data input terminal N1 of the latch circuit 701 that belongs to the first pixel 401, an electric potential N1b of the data input terminal N1 of the latch circuit 702 that belongs to the second pixel 402, an electric potential Vcom of the common electrode 37, an electric potential Va of the pixel electrode 35 that belongs to the first pixel 401, and an electric potential Vb of the pixel electrode 35 that belongs to the second pixel 402.

Hereinafter, the first driving method will be described in detail. First, in a turn-off period ST0 shown in FIG. 8, the electrophoretic display device 100 is in a turn-off state, and each wire connected to each of the pixels 40 is in a high impedance state (Hi-Z). Thus, the latch circuits 701 of the first pixel 401 and the latch circuit 702 of the second pixel 402 are in a turn-off state, and the content of memory of them are lost. In FIG. 9A, in order to indicate that the latch circuits 701 and 702 are in a turn-off state, these are indicated by the dotted-line symbol.

Note that the state of each electrophoretic element 32 in the above turn-off state is unstable because it is determined by the operation just before entering a turn-off state; however, in the present example, as shown in FIG. 9A, it is assumed that the entire display unit 5 displays white (all white display). However, the state of the display unit 5 in the turn-off period ST0 is selectable. The entire display unit 5 may display black or gray or may be a state in which an image is displayed.

Next, power of the electrophoretic display device 100 is turned on to supply a power to the controller 63, and the like, thus executing a start-up sequence. By so doing, the initial image display step ST11 included in the start-up sequence is executed. First, in the memory initialization step ST11A, as shown in FIG. 8, the high-potential power supply line 50 and the low-potential power supply line 49 are input with predetermined power supply electric potentials (high level electric potential VH; for example, 15 V, low level electric potential VL; for example, 0 V), and the latch circuits 701 and 702 enter a turn-on state.

Here, in the electrophoretic display device 100 of the present embodiment, the latch circuit 701 of the first pixel 401 and the latch circuit 702 of the second pixel 402 are designed so as to be stable in respective predetermined electric potentials owing to the supplied power supply voltage. Thus, as shown in FIG. 8, the first pixel 401 is initialized to a state in which the electric potential N1a of the data input terminal N1 of the latch circuit 701 is at a low level electric potential VL (Vss). In addition, the second pixel 402 is initialized to a state in which the electric potential N1b of the data input terminal N1 of the latch circuit 702 is at a high level electric potential VH (Vdd).

In FIG. 9B, the first and second pixels 401 and 402, which are in an initialized state, are conceptually shown. In the drawing, the latch circuit 701 of the first pixel 401 is indicated by the solid rectangular symbol, and the latch circuit 702 of the second pixel 402 is indicated by the outline circular symbol. Note that the state in which the latch circuit 701 holds a low level electric potential VL coincides with the state of an electric potential of the latch circuit 701 when the first pixel 401 displays black, so in FIG. 9B, the symbol that indicates the latch circuit 701 is conceptually shown by the solid symbol. In addition, the state in which the latch circuit 702 holds a high level electric potential VH coincides with the state of an electric potential of the latch circuit 702 when the second pixel 402 displays white, the symbol that indicates the latch circuit 702 is conceptually shown by the outline symbol.

In addition, as shown in FIG. 8, because the data output terminals N2 of the latch circuits 701 and 702 are respectively connected to the corresponding pixel electrodes 35, in the above initialized state, the electric potential Va of the pixel electrode 35 that belongs to the first pixel 401 is a high level electric potential VH, the electric potential Vb of the pixel electrode 35 that belongs to the second pixel 402 is a low level electric potential VL. However, in the period during which the memory initialization step ST11A is executed, because the common electrode 37 is in a high impedance state, the electrophoretic elements 32 are not driven, and the display unit 5 continuously performs all white display.

In addition, in the memory initialization step ST11A, the high-potential power supply line 50 and the low-potential power supply line 49 that are connected to the latch circuit 701 or 702 are driven; however, the scanning line driving circuit 61 and the data line driving circuit 62 are not driven. Thus, the scanning line 66, the data line 68 and the common electrode line 55 (Vcom) that are connected to each pixel 40 (401 or 402) all are maintained in a high impedance state.

Next, in the image display step ST11B, the common power source modulation circuit 64 is driven and, as shown in FIG. 8, a rectangular pulse is input to the common electrode 37. This pulse periodically repeats a high level electric potential VH (for example, 15 V) and a low level electric potential VL (for example, 0 V) and has a pulse width of, for example, about 10 to 500 ms.

Then, when the pulse is input to the common electrode 37, a potential difference is generated between the pixel electrode 35 (Va: high level electric potential VH) of the first pixel 401 and the common electrode 37 in a period during which the common electrode 37 is at a low level electric potential VL, and the electrophoretic element 32 is driven by the potential difference. Thus, as shown in FIG. 5B, the first pixel 401 displays black. On the other hand, in a period during which the common electrode 37 is at a high level electric potential VH, a potential difference is generated between the pixel electrode 35 (Vb: low level electric potential VL) of each second pixel 402 and the common electrode 37, and the electrophoretic element 32 is driven by the potential difference. Thus, as shown in FIG. 5A, the second pixel 402 displays white. In this way, as shown in FIG. 9C, a logo image “LOGO” formed of the black-display first pixels 401 with the background of the white-display second pixels 402 is displayed on the display unit 5.

After that, in the turn-off step ST12, as shown in FIG. 8, each wire connected to each of the pixels 40 (401 and 402) is caused to enter a high impedance state. Thus, the logo image on the display unit 5 is held without consuming electric power. In this manner, an initial image display operation (logo image display operation) in the start-up sequence is complete. After that, when execution of the remaining start-up sequence is complete, it enters a normal image display operation mode in which image data input from the outside or image data held in the internal memory are displayed on the display unit 5.

According to the above described first driving method, only by supplying power to the latch circuits 701 and 702 of the pixels 40 (401 and 402) that constitute the display unit 5, the display unit 5 is able to hold the image data corresponding to the logo image. Thus, it is possible to quickly display a logo image on the display unit 5 only by driving the common electrode 37 immediately after power of the electrophoretic display device 100 is turned on. In addition, it is not necessary to drive the scanning line driving circuit 61 or the data line driving circuit 62 for logo image display. Thus, a logo image may be displayed with extremely low power consumption and, therefore, it may be appropriately applied to an electrophoretic display device powered by battery. Furthermore, because a logo image is displayed immediately after power is turned on, it is possible to execute an initializing operation of various circuits and/or load image data from a memory utilizing a period of time during which the logo image is displayed. In addition, it is possible to notify the user using a logo image that the device is starting up or data are being loaded.

### Second Driving Method (Alarm Display Utilizing Initialized State)

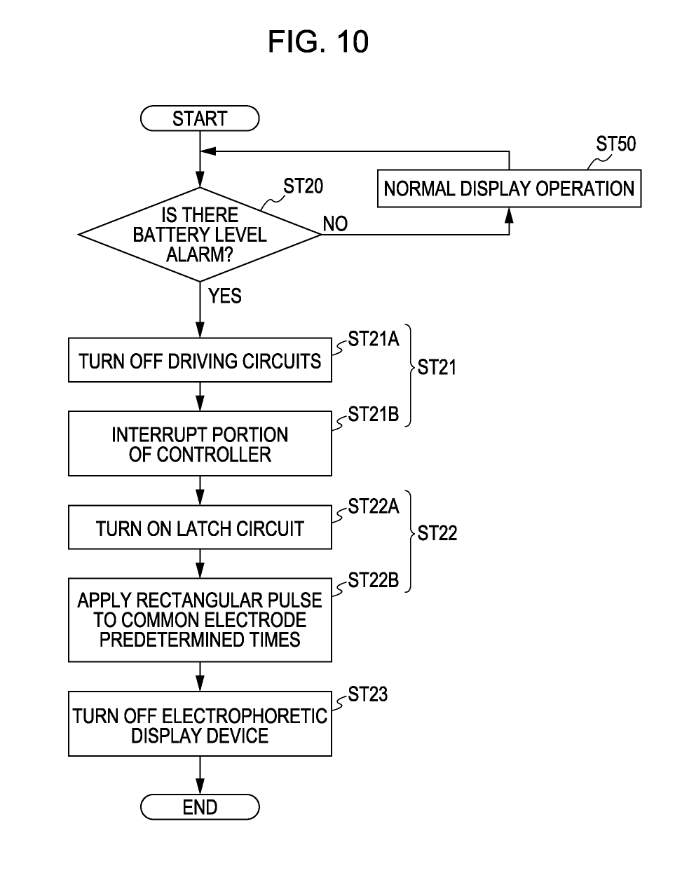

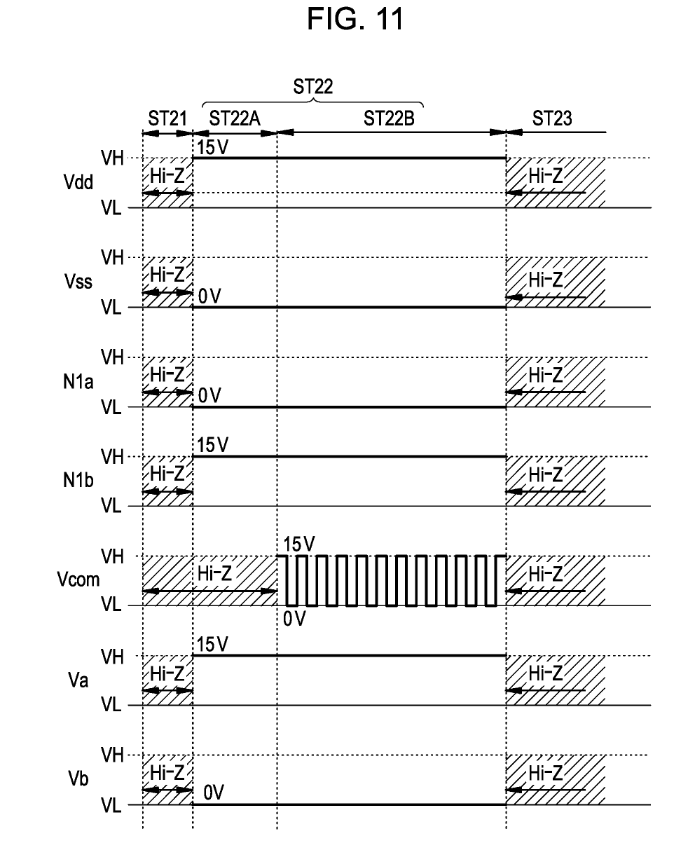

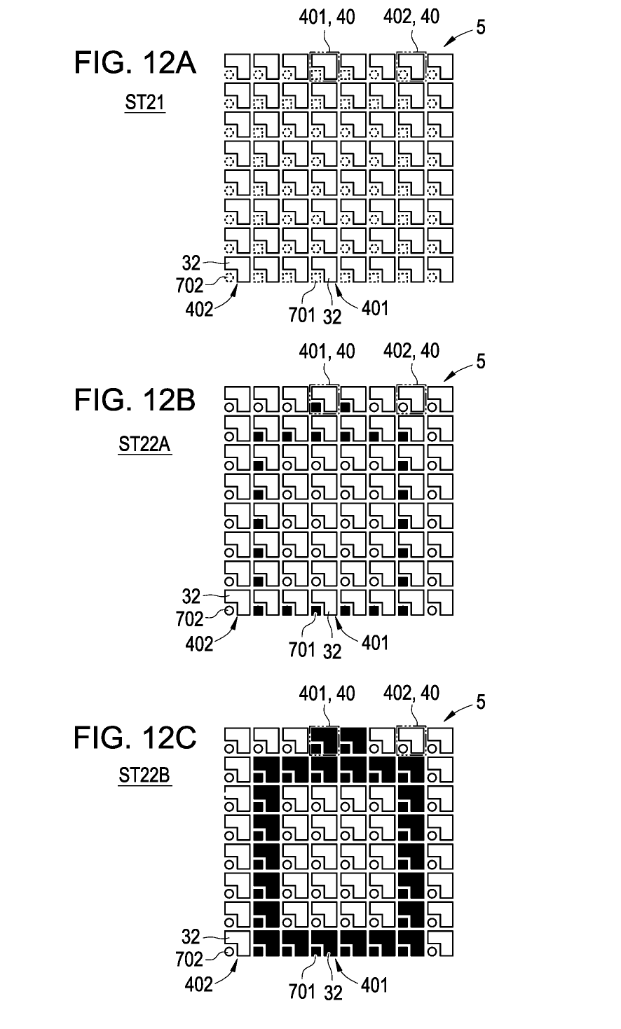

Next, another example in which an image is displayed utilizing an initialized state will be described with reference to FIG. 10 to FIG. 12C. FIG. 10 is a flowchart that shows a second driving method. FIG. 11 is a timing chart associated with FIG. 10. FIG. 11 is a view corresponding to FIG. 8 of the first driving method, and the electric potentials of portions shown in FIG. 11 are similar to those of FIG. 8. FIG. 12A, FIG. 12B and FIG. 12C are views that illustrate changes in state of the display unit 5 through the second driving method.

The second driving method constitutes portion of an alarm display sequence of the electrophoretic display device 100. That is, the second driving method executes an operation by which an alarm image that is formed in the display unit 5 in advance is displayed when the battery level is low during operation of the electrophoretic display device 100.

The electrophoretic display device 100, to which the second driving method is applied, includes a power supply voltage monitoring circuit 65 connected to the controller 63 as shown in FIG. 1. In addition, as shown in FIG. 12A to FIG. 12C, the pixels 40 formed of the first pixel 401 and the pixels 40 formed of the second pixel 402 are mixedly arranged in the display unit 5 so as to form a specific alarm image by the first and second pixels 401 and 402. Specifically, as shown in FIG. 12C, the first pixels 401 shown as solid pixels are arranged so as to form a black alarm image (image of empty battery) on the display unit 5, and the second pixels 402 shown as outline pixels are arranged as background in the region other than the first pixels 401. Note that, in FIG. 12A to FIG. 12C, as in the same manner as FIG. 9A to FIG. 9C, each of the first pixels 401 is shown by the latch circuit 701 and the electrophoretic element 32, and each of the second pixels 402 is shown by the latch circuit 702 and the electrophoretic element 32.

As shown in FIG. 10, the second driving method includes step ST20 in which it is determined whether there is a battery level alarm, and, on the basis of the result of determination in step ST20, any one of step ST21 to step ST23 and step ST50 is executed. The step ST21 to step ST23 are executed in the alarm display operation. The step ST50 is executed in the normal display operation. Steps associated with the alarm display operation include a stand-by step ST21 in which the electrophoretic display device 100 is shifted into a stand-by mode, an initial image display step ST22 in which an initial image prepared as an alarm image is displayed, and a power turn-off step ST23 in which power of the electrophoretic display device is interrupted.

Hereinafter, the second driving method will be described in detail. In the second driving method, the step ST20 shown in FIG. 10 is executed by inputting an interrupt signal from the power supply voltage monitoring circuit 65 to the controller 63. That is, when an alarm signal that indicates a low battery level is input from the power supply voltage monitoring circuit 65 that monitors a battery level to the controller 63, the controller 63 executes not the step ST50 in which the normal display operation is performed but the step ST21 to step ST23 in which the alarm image is displayed.

In the operation to display the alarm image, first, the stand-by step ST21 is executed. The stand-by step ST21 includes step ST21A in which power of each driving circuit is turned off and step ST21B in which portion of the controller 63 is interrupted. First, in step ST21A, the scanning line driving circuit 61 and the data line driving circuit 62 are placed in a turn-off state, and the high-potential power supply lines 50 and the low-potential power supply lines 49 that supply a power supply voltage to the pixels 40 are electrically disconnected. That is, after an alarm signal of a low battery level is input, supply of power is interrupted so as not to consume electric power in the display unit 5. Thus, as shown in FIG. 11, each wire connected to each pixel 40 enters a high impedance state.

Next, in step ST21B, the circuits that constitute the controller 63 but not used in the following operation (alarm display) or in a return operation are interrupted. For example, a frame memory, by which image data transmitted to the display unit 5 are generated, and its control circuit, circuits that execute arithmetic processing on image data, and the like, are interrupted. In some cases, the power supply voltage monitoring circuit 65 may be interrupted. Thus, power consumed in the controller 63 is suppressed, and power used for alarm image display is easily ensured.

Note that in the second driving method, when it is possible to ensure the residual amount of battery by which the alarm image display may be reliably performed in the following initial image display step ST22, the stand-by step ST21 may be omitted. However, in this case as well, in order to place the latch circuits 701 and 702 of the pixels 40 in an initialized state, the high-potential power supply lines 50 and the low-potential power supply lines 49 need to be placed in a high impedance state at least once.

Next, the initial image display step ST22 is executed. As shown in FIG. 10, the initial image display step ST22 executes the memory initialization step ST22A in which power of the latch circuits 701 and 702 is turned on and the image display step ST22B in which a predetermined pulse is input to the common electrode 37. FIG. 11 shows a timing chart according to a series of operations including the initial image display step ST22.

A specific operation in the initial image display step ST22 is similar to that of the initial image display step ST11 in the first driving method. First, in the memory initialization step ST22A, as shown in FIG. 11 and FIG. 12A to FIG. 12C, supply of power to the latch circuits 701 and 702 that are placed in a turn-off state in the stand-by step ST21 is resumed. Thus, as shown in FIG. 12B, the latch circuits 701 and 702 enter an initialized state in which the latch circuits 701 and 702 respectively hold predetermined electric potentials (image signals). Subsequently, in the initial image display step ST22B, a rectangular pulse is input to the common electrode 37. Thus, as shown in FIG. 12C, the electrophoretic element 32 of each of the pixels 40 (401 and 402) is driven, and then each first pixel 401 displays black, and each second pixel 402 displays white. As a result, the alarm image is displayed on the display unit 5.

When the alarm image is displayed on the display unit 5, the power turn-off step ST23 is executed. In the power turn-off step ST23, power of the electrophoretic display device 100 is interrupted. Thus, as shown in FIG. 11, each wire connected to each of the pixels 40 (401 and 402) is caused to enter a high impedance state. The alarm image displayed on the display unit 5 in the initial image display step ST22 is held in its display state owing to the memory property of each electrophoretic element 32.

As described above, in the second driving method, when a power supply voltage is low, the alarm image, which is an initial image that is formed in the display unit 5 in advance, is displayed. Then, this alarm image display may be executed without driving the scanning line driving circuit 61 or the data line driving circuit 62, so power consumed in the display operation is extremely low. Thus, even a battery having a low residual amount is probably able to execute the display operation.

Note that the second driving method may also be suitably used in a wirelessly-powered or solar-powered electrophoretic display device. In these driving system, power of a power source is small and, in addition, supply of power is suddenly interrupted; however, when a capacitor having a sufficient capacitance is provided for a power source mounted on the electrophoretic display device, it is possible to reliably display an alarm image.

In addition, when the stand-by step ST21 is executed prior to the initial image display step ST22, power consumption of circuits that are unnecessary for alarm display may be suppressed. Thus, power for alarm image display is easily ensured and, therefore, it is possible to further enhance the reliability of alarm image display.

### Third Driving Method (Image Deletion Utilizing Initialized State)

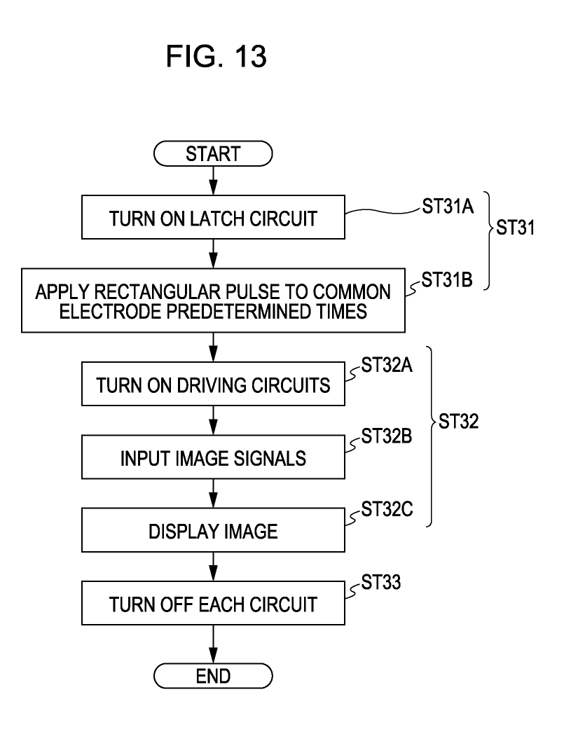

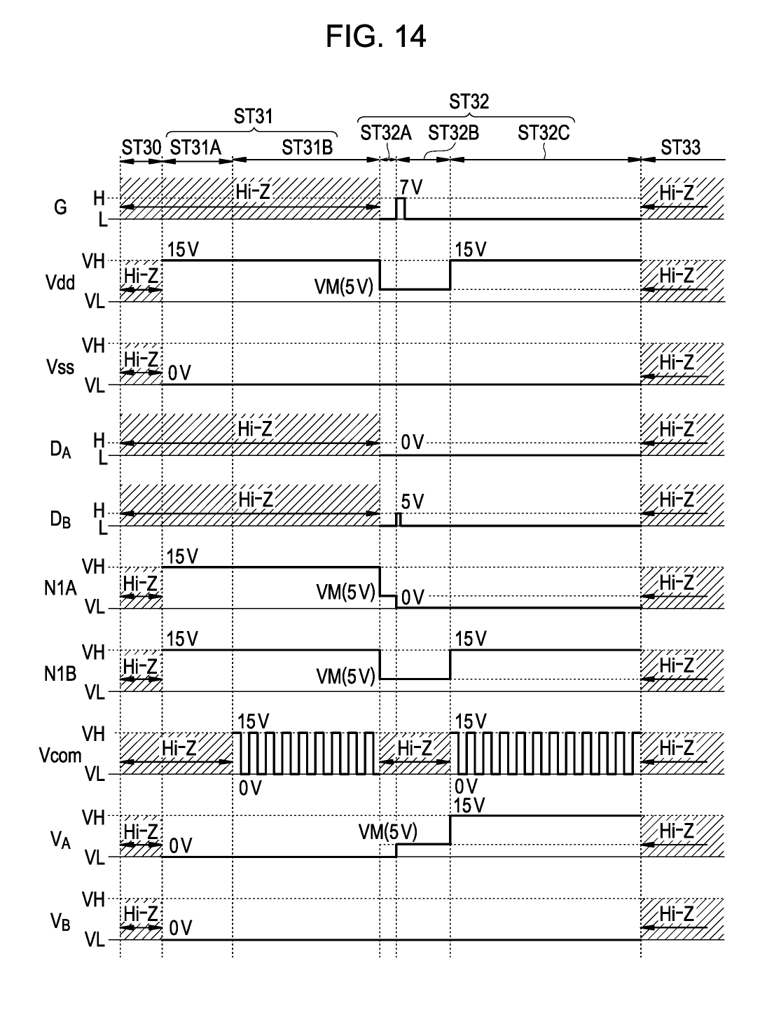

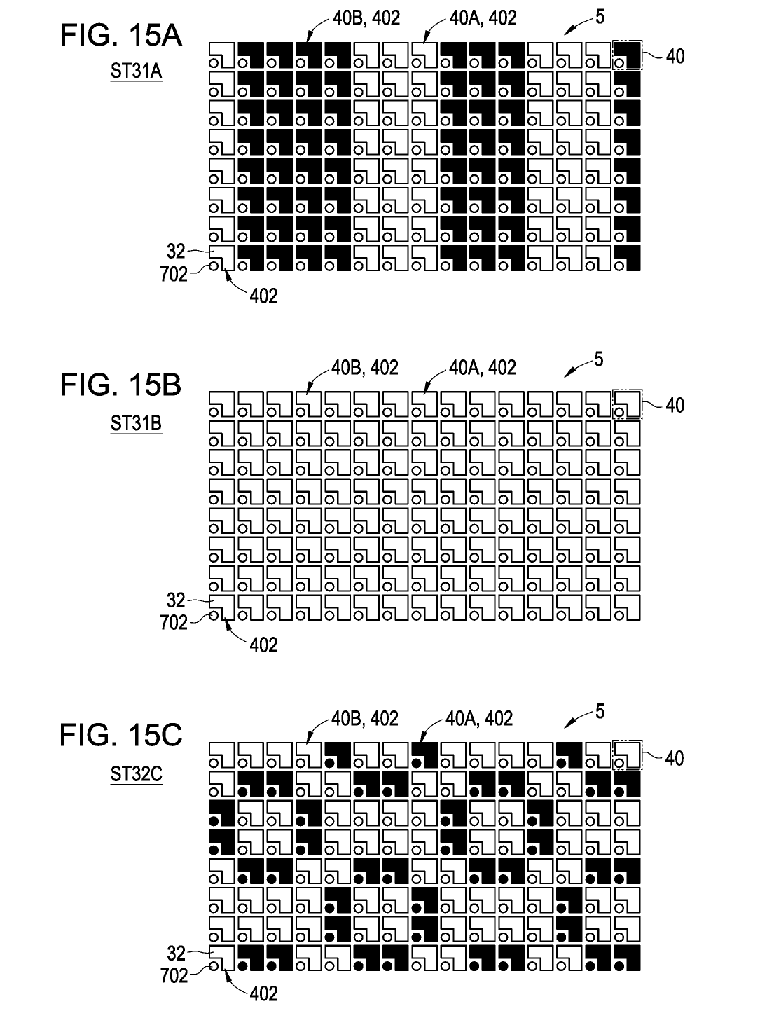

Next, an example in which an image is deleted utilizing an initialized state will be described with reference to FIG. 13 to FIG. 15C. FIG. 13 is a view that shows a flowchart according to a third driving method. FIG. 14 is a timing chart associated with FIG. 13. FIG. 15A, FIG. 15B and FIG. 15C are views that illustrate changes in state of the display unit 5 through the third driving method.

The third driving method constitutes portion of an image update sequence of the electrophoretic display device 100. That is, the third driving method executes an operation to delete an image displayed on the display unit 5 and an operation to display an image based on new image data on the display unit 5 from which the display has been deleted.

In the electrophoretic display device 100 to which the third driving method is applied, the display unit 5 is formed so that the second pixels 402 shown as outline pixels are arranged over the entire display unit 5 as shown in FIG. 15B. Note that, in FIG. 15A to FIG. 15C, as in the same manner as FIG. 9A to FIG. 9C, each of the second pixels 402 is shown by the latch circuit 702 and the electrophoretic element 32.

In addition, in the present embodiment, an example in which the display unit 5 is formed of only the second pixel 402 and then an image on the display unit 5 is deleted in white (all white display) through execution of the image deletion step ST31 will be described. Of course, the display unit 5 may be formed of only the first pixel 401 instead. When the display unit 5 is formed of only the first pixel 401, an image on the display unit 5 is deleted in black (all black display) in the image deletion step ST31.

As shown in FIG. 13, the third driving method includes the image deletion step ST31 in which an image on the display unit 5 is deleted, an updated image display step ST32 (image display period) in which a new image is displayed on the display unit 5, and a turn-off step ST33 in which power of each circuit connected to the display unit 5 is turned off.

FIG. 14 shows a timing chart according to a series of operations including the above step ST31 to step ST33. In addition, FIG. 14 shows electric potentials of terminals and electrodes in two pixels 40A and 40B that are selected from among the pixels 40 (second pixels 402) shown in FIG. 15A to FIG. 15C. Specifically, FIG. 14 shows an electric potential Vdd of the high-potential power supply line 50 (high-potential power supply terminal PH), an electric potential Vss of the low-potential power supply line 49 (low-potential power supply terminal PL), an electric potential D_{A} of the data line 68 connected to the pixel 40A, an electric potential D_{B} of the data line 68 connected to the pixel 40B, an electric potential N1A of the data input terminal N1 of the latch circuit 702 that belongs to the pixel 40A, an electric potential N1B of the data input terminal N1 of the latch circuit 702 that belongs to the pixel 40B, an electric potential Vcom of the common electrode 37, an electric potential V_{A} of the pixel electrode 35 that belongs to the pixel 40A, and an electric potential V_{B} of the pixel electrode 35 that belongs to the pixel 40B.

Hereinafter, the third driving method will be described in detail. First, in the turn-off period ST30 shown in FIG. 14, each circuit connected to the display unit 5 is placed in a turn-off state, and each wire connected to each of the pixels 40 is in a high impedance state. That is, an image displayed on the display unit 5 in the previous frame is held.

Then, when an image update operation is started, the image deletion step ST31 is executed. The image deletion step ST31 is an initial image display step according to the aspects of the invention, and includes a memory initialization step ST31A and a white image display step ST31B. A specific operation in the image deletion step ST31 is similar to that in the initial image display step ST11 in the above described first driving method or that in the initial image display step ST22 in the above described second driving method.

In the image deletion step ST31, first, the memory initialization step ST31A is executed. In the memory initialization step ST31A, as shown in FIG. 14, the high-potential power supply line 50 and the low-potential power supply line 49 are input with predetermined power supply electric potentials (high level electric potential VH; for example, 15 V, low level electric potential VL; for example, 0 V), and the latch circuit 702 of each pixel 40 enters a turn-on state. Thus, as shown in FIG. 14, the latch circuits 702 of all the pixels 40 are initialized to a state in which the electric potential (N1A or N1B) of the data input terminal N1 is the high level electric potential VH.

FIG. 15A schematically shows the pixels 40 in the initialized state. That is, the electrophoretic elements 32 of the pixels 40 hold a display state (striped pattern in the drawing) in the turn-off period ST30, and the latch circuits 702 of all the pixels 40 equally hold the high level electric potential VH (Vdd). Note that the reason why the display unit 5 does not change the display is because the common electrode 37 is in a high impedance state during a period of the memory initialization step ST31A.

Next, in the image display step ST31B, as shown in FIG. 14, a rectangular pulse that periodically repeats the high level electric potential VH (for example, 15 V) and the low level electric potential VL (for example, 0 V) is input to the common electrode 37. Thus, in a period during which the common electrode 37 is at the high level electric potential VH, a potential difference is generated between the pixel electrode 35 (V_{A}, V_{B}: low level electric potential VL) of each pixel 40 and the common electrode 37, and the electrophoretic element 32 is driven by the potential difference. As a result, as shown in FIG. 15B, all the pixels 40 display white, and the image on the display unit 5 is deleted by the white-display pixels 40 (all white deletion). Note that, in the white image display step ST31B, because all the pixel electrodes 35 of the display unit 5 are at the low level electric potential VL, a signal that is input to the common electrode 37 during that period need not be a rectangular pulse, but it may be a constant potential signal of the high level electric potential VH.

When the image on the display unit 5 is deleted, the updated image display step ST32 is executed. As shown in FIG. 13, the updated image display step ST32 includes a turn-on step ST32A, an image signal input step ST32B, and an image display step ST32C.

First, in the turn-on step ST32A, a power supply voltage is supplied to the scanning line driving circuit 61 and the data line driving circuit 62, and then each circuit turns on. In addition, each wire of each pixel 40 is electrically connected by the driving circuits and enters a state in which a signal can be input. Specifically, the low level (L: for example, 0 V) is input to the scanning lines 66 and the data lines 68.

In addition, in this step, the electric potential

Vdd of the high-potential power supply line 50 is lowered from the high level electric potential VH in the initial image display step ST31B to a high level electric potential VM (for example, 5 V) for inputting an image signal. By so doing, the holding voltage (electric potentials N1A, N1B) of each latch circuit 702 is also lowered from the high level electric potential VH to the high level electric potential VM for inputting an image signal. Thus, even when the data line driving circuit 62 is driven at a low voltage (5 V), an image signal may be written to each latch circuit 702.

Next, in the image signal input step ST32B, a selection signal (at a high level of 7 V) is input to the scanning line 66. Thus, the driving TFTs 41 of the pixels 40 corresponding to the selected scanning line 66 turn on, and image signals corresponding to a display image are input from the data lines 68 connected to the selected pixels 40 to the latch circuits 702. Each latch circuit 702 stores the input image signal.

A low level (L) image signal is input to the latch circuit 702 of each pixel 40A shown in FIG. 15A to FIG. 15C, and the electric potential N1A of the data input terminal N1 attains the low level electric potential VL. In addition, the electric potential V_{A} of the pixel electrode 35 connected to the data output terminal N2 of the latch circuit 702 of each pixel 40A becomes the high level electric potential VM. On the other hand, a high level (H) image signal is input to the latch circuit 702 of each pixel 40B, and the electric potential N1 of the data input terminal N1 becomes the high level electric potential VM.

In addition, the electric potential V_{B} of the pixel electrode 35 connected to the data output terminal N2 of the latch circuit 702 of each pixel 40B becomes the low level electric potential VL.

In this manner, when image signals are input to all the pixels 40, the image display step ST32C is executed. In the image display step ST32C, the electric potential Vdd of the high-potential power supply line 50 is raised from the high level electric potential VM (for example, 5 V) for inputting an image signal to the high level electric potential VH (for example, 15 V) for image display. The electric potential of the low-potential power supply line 49 remains at the low level electric potential VL (for example, 0 V). Thus, in each pixel 40A, the electric potential output from the data output terminal N2 of the latch circuit 702 is raised to the high level electric potential VH, and the electric potential V_{A} of the pixel electrode 35 is also raised to the high level electric potential VH. Note that in each pixel 40B, the electric potential V_{B} (low level electric potential VL) of the pixel electrode 35 remains unchanged.

In addition, a rectangular pulse that periodically repeats the high level electric potential VH (for example, 15 V) and the low level electric potential VL (for example, 0 V) is input to the common electrode 37. In each pixel 40A, the electric potential V_{A} of the pixel electrode 35 is at the high level electric potential VH, so in a period during which the common electrode 37 is at the low level electric potential VL, the electrophoretic element 32 is driven by a potential difference between the pixel electrode 35 and the common electrode 37 and then displays black as shown in FIG. 15C. On the other hand, in each pixel 40B, the electric potential V_{B} of the pixel electrode 35 is at the low level electric potential VL, so in a period during which the common electrode 37 is at the high level electric potential VH, each electrophoretic element 32 is driven by a potential difference between the pixel electrode 35 and the common electrode 37 and then displays white as shown in FIG. 15C. In this manner, as shown in FIG. 15C, an image (circular pattern in the drawing) based on the image signal written to each pixel 40 is displayed on the display unit 5.

After that, the turn-off step ST33 is executed and, as shown in FIG. 14, each wire connected to each of the pixels 40 is caused to enter a high impedance state. Thus, the image on the display unit 5 is held without consuming electric power.

As described above, according to the third driving method, after all the latch circuits 702 of the display unit 5 are caused to enter a turn-off state, power is just turned on again to drive the common electrode 37. Thus, all the pixels 40 of the display unit 5 display white to thereby make it possible to delete the displayed image. Then, for the image deletion operation, it is not necessary to operate the scanning line driving circuit 61 and the data line driving circuit 62. Thus, it is possible to delete an image with an extremely low power consumption. Thus, it is possible to suppress power consumption to a lesser degree when the electrophoretic display device 100 is operated.

### Third Embodiment

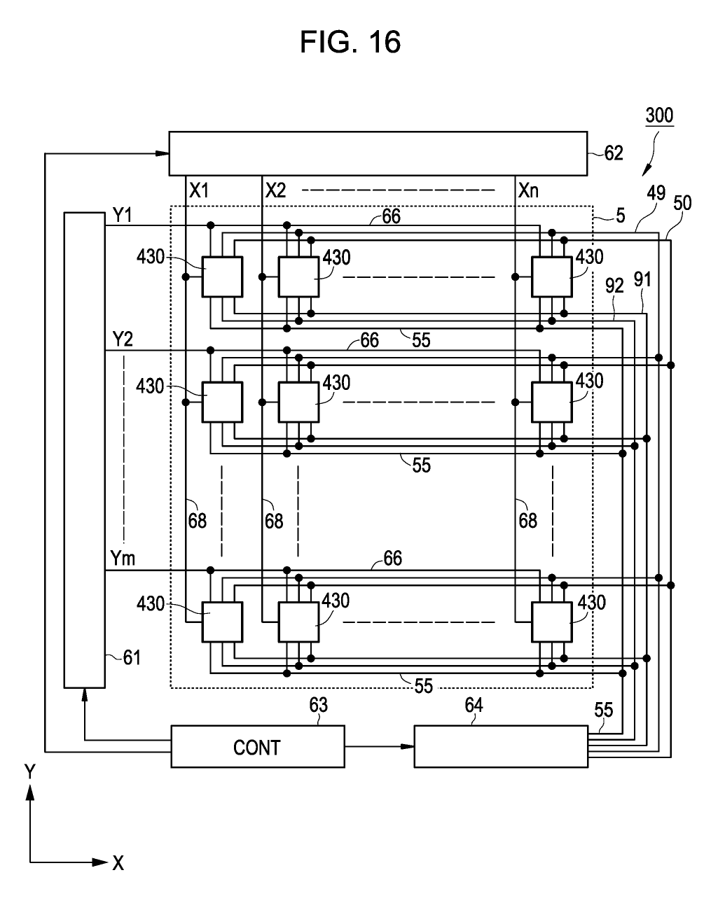

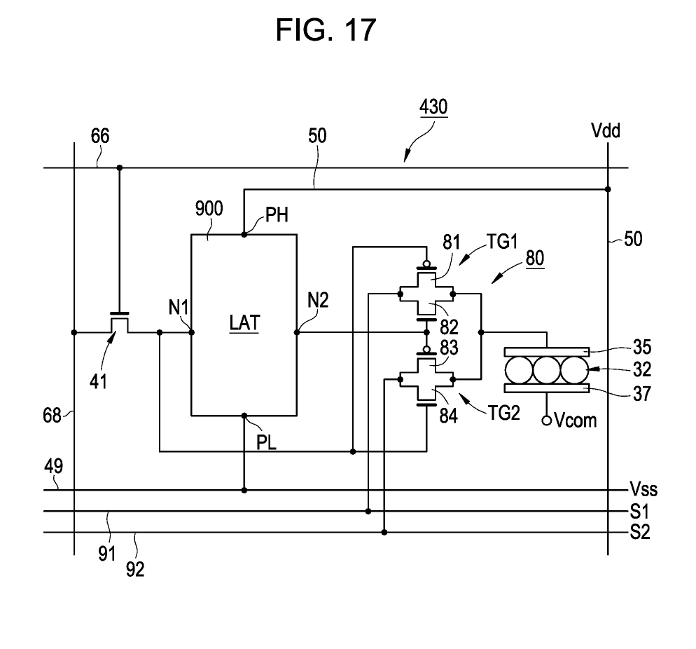

FIG. 16 is a schematic block diagram of an electrophoretic display device 300 according to a third embodiment of the invention. FIG. 17 is a circuit configuration diagram of a pixel 430 provided for the electrophoretic display device 300. In the above described first and second embodiments and alternative examples thereof, the electrophoretic display device includes the pixels 40, each of which has the pixel electrode 35 that is directly connected to the data output terminal N2 of the latch circuit 701, and the like. The structure of each pixel of the electrophoretic display device according to the aspects of the invention may also employ the pixel 430 shown in FIG. 17. Note that in FIG. 16 and FIG. 17, like reference numerals denote like components to those in the drawings referenced in the above embodiments, and the detailed description thereof is omitted.

As shown in FIG. 16, the electrophoretic display device 300 includes the display unit 5 in which a plurality of the pixels 430 are arranged, and the scanning line driving circuit 61, the data line driving circuit 62, the controller 63 and the common power source modulation circuit 64 are arranged around the display unit 5. A first control line 91 and a second control line 92 extending from the common power source modulation circuit 64 extend in the display unit 5 in addition to the scanning lines 66, the data lines 68 and the common electrode line 55.

The pixel 430 includes the driving TFT 41, a latch circuit 900, a switch circuit 80, the pixel electrode 35, the electrophoretic element 32 and the common electrode 37. The pixel 430 is connected to the scanning line 66, the data line 68, the low-potential power supply line 49, the high-potential power supply line 50, the first control line 91 and the second control line 92.

The latch circuit 900 is formed of the latch circuit according to the first and second embodiments and the alternative examples thereof. That is, the latch circuit 900 is formed of the latch circuit 701, 702, 801, 802, 801A, or the like, shown in FIG. 2A, FIG. 2B, FIG. 6A, FIG. 6B, FIG. 27A and FIG. 27B. When the latch circuit 900 is formed of the same configuration as any one of the latch circuits 701, 801 and 801A, the pixel 430 operates as in the same manner as the first pixel 401, 501 or 501A in the above described embodiments. On the other hand, when the latch circuit 900 is formed of the same configuration of any one of the latch circuits 702 and 802, the pixel 430 operates as in the same manner as the second pixel 402 or 502.

The switch circuit 80 is connected between the latch circuit 900 and the pixel electrode 35. The switch circuit 80 has a first transmission gate TG1 and a second transmission gate TG2. The first transmission gate TG1 has a P-MOS transistor 81 and an N-MOS transistor 82. The source terminal of the P-MOS transistor 81 and the source terminal of the N-MOS transistor 82 are connected to the first control line 91, and the drain terminal is connected to the pixel electrode 35. The gate terminal of the P-MOS transistor 81 is connected to the data input terminal N1 (drain terminal of the driving TFT 41) of the latch circuit 900, and the gate terminal of the N-MOS transistor 82 is connected to the data output terminal N2 of the latch circuit 900.

The second transmission gate TG2 has a P-MOS transistor 83 and an N-MOS transistor 84. The source terminal of the P-MOS transistor 83 and the source terminal of the N-MOS transistor 84 are connected to the second control line 92, and the drain terminals of them are connected to the pixel electrode 35. The gate terminal of the P-MOS transistor 83 is connected to the data output terminal N2 of the latch circuit 900, and the gate terminal of the N-MOS transistor 84 is connected to the data input terminal N1 of the latch circuit 900.

In the thus configured electrophoretic display device 300 of the present embodiment, to display an image on the display unit 5, an image signal is input through the driving TFT 41 to the data input terminal N1 of the latch circuit 900 and is stored in the latch circuit 900 as an electric potential. Then, an electric potential corresponding to the image signal is output from the data input terminal N1 and data output terminal N2 of the latch circuit 900 and is then input to the switch circuit 80.

For example, if the electric potential Vdd of the high-potential power supply line 50 is the high level electric potential VH, and the electric potential Vss of the low-potential power supply line 49 is the low level electric potential VL, and when the latch circuit 900 holds a low level image signal, the data input terminal N1 is at the low level electric potential VL (Vss), and the data output terminal N2 is at the high level electric potential VH (Vdd). Thus, the first transmission gate TG1 of the switch circuit 80 turns on, and the first control line 91 is connected to the pixel electrode 35. Thus, the electric potential S1 (for example, high level electric potential VH) of the first control line 91 is input to the pixel electrode 35 as an electric potential for image display.

On the other hand, when the latch circuit 900 holds a high level image signal, the data input terminal N1 is at the high level electric potential VH (Vdd), and the data output terminal N2 is at the low level electric potential VL (Vss). Thus, the second transmission gate TG2 of the switch circuit 80 turns on, and the second control line 92 is connected to the pixel electrode 35. Thus, the electric potential S2 (for example, low level electric potential VL) of the second control line 92 is input to the pixel electrode 35 as an electric potential for image display.

Then, when a rectangular pulse that periodically repeats the high level electric potential VH and the low level electric potential VL is, for example, input to the common electrode 37, it is possible for the pixel 430 to display black or white on the basis of a potential difference between the pixel electrode 35 and the common electrode 37.

In the electrophoretic display device 300 of the present embodiment, the latch circuit 900 is formed of any one of the latch circuits 701, 702, 801 and 802 according to the first and second embodiments. Thus, the same function and advantageous effects as those of the electrophoretic display devices 100 and 200 according to the first and second embodiments may be obtained. That is, when only specific pixels, for example, employ the pixels 430 (first pixels) that have the latch circuit 701 (801), and the other pixels employ the pixels 430 (second pixels) that have the latch circuit 702 (802), it is possible to display a predetermined image (logo, or the like) when power is turned on or display an alarm image when a predetermined condition is satisfied. In addition, when the entire display unit 5 is formed of the first pixel or the second pixel, the entire display unit is able to perform all black display or all white display when power is turned on. Thus, it is possible to execute the same operation as the image deletion operation.

Note that in the case of the present embodiment, the electric potential input to each pixel electrode 35 is the electric potential of the first control line 91 or second control line 92, which is selected by the switch circuit 80. Thus, to display an initial image on the display unit 5 after the latch circuit 900 is placed in an initialized state, it is necessary to input an electric potential to the first and second control lines 91 and 92. That is, in the image display step ST11B of the first driving method, the image display step ST22B of the second driving method, and the image display step ST31B of the third driving method, together with a signal input to the common electrode 37, it is necessary to input an electric potential to the first and second control lines 91 and 92.

In addition, in the electrophoretic display device 300 of the present embodiment, the switch circuit 80 is connected between the latch circuit 900 and the pixel electrode 35. Thus, by adjusting the electric potentials of the first and second control lines 91 and 92 connected to the switch circuit 80, it is possible to control display of the display unit 5 without using a holding potential of the latch circuit 900. For example, the high level electric potential VH and the low level electric potential VL input to the first and second control lines 91 and 92 are interchanged, and a rectangular pulse that repeats the high level electric potential VH and the low level electric potential VL at predetermined intervals is input to the common electrode 37. Thus, it is possible to invert a display image of the display unit 5. In addition, by adjusting the first and second control lines 91 and 92, it is possible to execute a deletion operation on the display unit 5. That is, the high level electric potential VH is input to both the first and second control lines 91 and 92, and the low level electric potential VL is input to the common electrode 37. Thus, it is possible to delete an image on the display unit 5 by all black display.

Alternatively, the low level electric potential VL is input to both the first and second control lines 91 and 92, and the high level electric potential VH is input to the common electrode 37. Thus, it is possible to delete an image on the display unit 5 by all white display.

### Electronic Apparatus

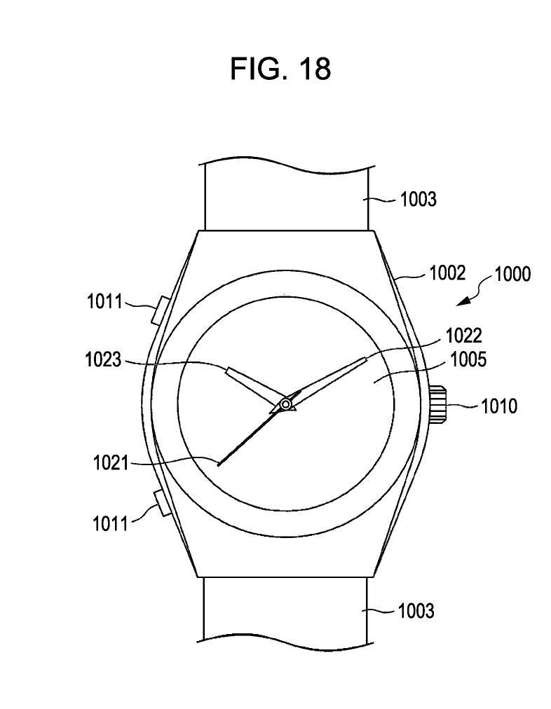

Next, an example in which the electrophoretic display device 100 (200, 300) according to the above described embodiments is applied to an electronic apparatus will be described. FIG. 18 is a front view of a watch 1000. The watch 1000 includes a watch housing 1002 and a pair of bands 1003 coupled to the watch housing 1002. A display unit 1005 formed of the electrophoretic display device 100 (200, 300) according to the above described embodiments, a second hand 1021, a minute hand 1022 and an hour hand 1023 are provided on the front face of the watch housing 1002. A crown 1010, which serves as an operating element, and an operating button 1011 are provided on the side of the watch housing 1002. The crown 1010 is coupled to a stem (not shown in the drawing) provided inside the housing, and is axially adjustable in multistage (for example, two stages) integrally with the stem and is rotatable. The display unit 1005 is able to display a background image, a character string such as date and/or time, a second hand, a minute hand, an hour hand, or the like.

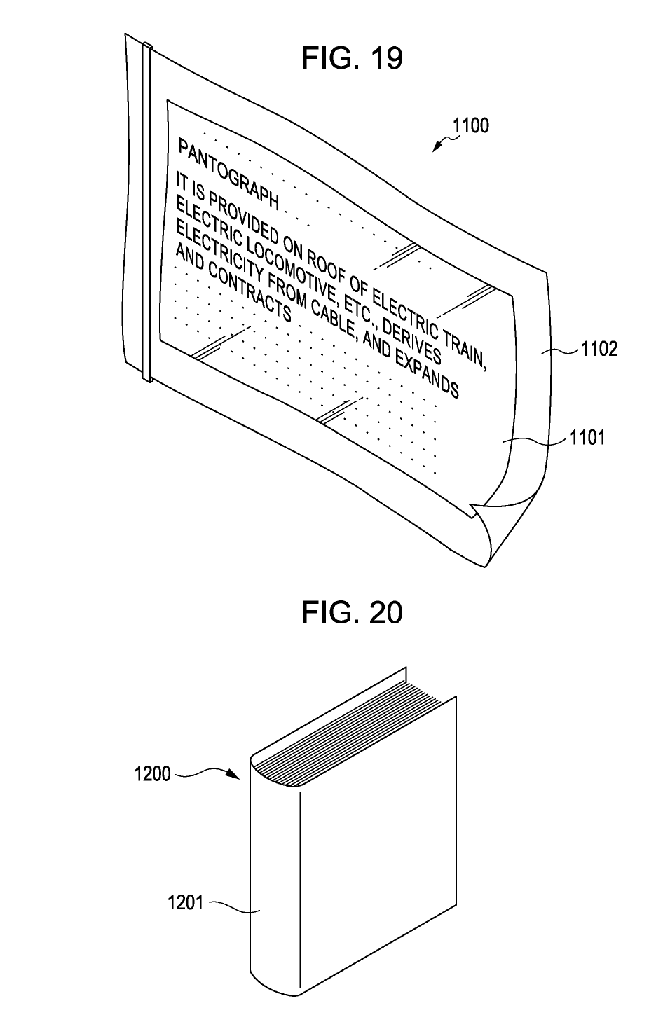

FIG. 19 is a perspective view that shows the configuration of an electronic paper 1100. The electronic paper 1100 includes the electrophoretic display device 100 (200, 300) according to the above described embodiments in a display area 1101. The electronic paper 1100 is flexible and has a body 1102 formed of a rewritable sheet having a texture and flexibility similar to an existing paper.

FIG. 20 is a perspective view that shows the configuration of an electronic notebook 1200. The electronic notebook 1200 is formed so that a plurality of the electronic papers 1100 are bound and held by a cover 1201. The cover 1201, for example, includes a display data input device (not shown) by which display data transmitted from an external device is input. Thus, in accordance with the display data, it is possible to change or update the contents of display while the electronic papers are bound.

According to the above described watch 1000, electronic paper 1100 and electronic notebook 1200, an image display unit employs the electrophoretic display device 100 (200, 300) according to the aspects of the invention. Thus, the electronic apparatuses each include a high-performance image display unit with high power-saving capability. Note that the electronic apparatuses shown in FIG. 18 to FIG. 20 merely illustrate the electronic apparatus according to the aspects of the invention and are not intended to limit the scope of the invention. For example, the image display unit of an electronic apparatus, such as a cellular phone and a portable audio instrument, may also suitably employ the electrophoretic display device according to the aspects of the invention.

### Example Embodiments

Hereinafter, the aspects of the invention will be described in greater detail by the example embodiments. FIG. 21 is a wiring layout diagram of one pixel in the electrophoretic display device according to the example embodiment of the invention. Note that FIG. 21 is a view that shows a basic configuration of a pixel layout, and pixel circuits according to the following first to sixth example embodiments respectively employ the latch circuits shown in FIG. 22 to FIG. 27B in place of the latch circuit 70 shown in FIG. 21.

The pixel 40 shown in FIG. 21 includes the driving TFT 41, the latch circuit 70, the scanning line 66, the data line 68, the low-potential power supply line 49, and the high-potential power supply line 50. Note that each of the wires, and the like, shown in FIG. 21 is formed in any one of a plurality of wiring layers laminated via interlayer insulating films. In the following description, the wiring layer in which a semiconductor layer that constitutes a TFT is formed is called “semiconductor forming layer”, the wiring layer in which the scanning line 66 and a gate electrode are formed is called “gate wiring layer”, and the wiring layer in which the data line 68, a source electrode and a drain electrode are formed are called “source wiring layer”, where appropriate.

The driving TFT 41 has a rectangular semiconductor layer 41a, a gate electrode 41b having a substantially U shape in plan view, two source electrodes 41c and 41d branched off from the data line 68, and a drain electrode 41e extending from above the semiconductor layer 41a toward the center of the pixel 40.

The gate electrode 41b is formed in a position such that the U-shaped two arms overlap the semiconductor layer 41a in plan view. A connecting portion 41f extends from the distal end of one of the arms of the gate electrode 41b. The connecting portion 41f extends to near the scanning line 66 that extends vertically in the drawing. A relay layer 66a having a rectangular shape in plan view is formed at the distal end portion of the connecting portion 41f and connects the connecting portion 41f (gate electrode 41b) with the scanning line 66. The relay layer 66a is connected through a contact hole H1 to the connecting portion 41f and connected through a contact hole H2 to the scanning line 66.

The source electrodes 41c and 41d are branched off from the data line 68, extending horizontally in the drawing, toward inner side (upper side in the drawing) of the pixel 40, and extend to the positions that overlap the semiconductor layer 41a at the left and right sides of the gate electrode 41b in plan view in the drawing. The source electrodes 41c and 41d and the semiconductor layer 41a are connected with each other through contact holes H3 and H4 that are formed at the respective overlapped positions.

The drain electrode 41e is connected to the semiconductor layer 41a through a contact hole H5 that is formed at a position that overlaps the semiconductor layer 41a in plan view. In addition, the drain electrode 41e is connected to a connecting wire 78 through a contact hole H6 that is formed in the distal end portion of the drain electrode 41e away from the semiconductor layer 41a. The connecting wire 78 connects the driving TFT 41 with the latch circuit 70.

The latch circuit 70 has a transfer inverter 70t and a feedback inverter 70f. In the latch circuit 70 shown in FIG. 21, the transfer inverter 70t is arranged at the upper side in the drawing, and the feedback inverter 70f is arranged at the lower side in the drawing.

The latch circuit 70 corresponds to the latch circuit 701 or 702 according to the first embodiment, the latch circuit 801 or 802 according to the second embodiment or the latch circuit according to the alternative examples of these embodiments. In addition, the transfer inverter 70t corresponds to the transfer inverter 701t or 702t according to the first embodiment, the transfer inverter 801t or 802t according to the second embodiment or the transfer inverter according to the alternative examples of these embodiments. Furthermore, the feedback inverter 70f corresponds to the feedback inverter 701f or 702f according to the first embodiment, the feedback inverter 801f or 802f according to the second embodiment or the feedback inverter according to the alternative examples of these embodiment.

The transfer inverter 70t has a semiconductor layer 75t, a gate electrode 76t and a drain electrode 77t, and has a P-MOS transistor 71 and an N-MOS transistor 72 that are formed of these components. In addition, the transfer inverter 70t is connected to a power supply line 50a and a power supply line 49a. The power supply line 50a is connected to the high-potential power supply line 50. The power supply line 49a is connected to the low-potential power supply line 49.

The P-MOS transistor 71 corresponds to the P-MOS transistor 711 or 712 according to the first embodiment, the P-MOS transistor 811 or 812 according to the second embodiment or the P-MOS transistor according to the alternative examples of these embodiments. The N-MOS transistor 72 corresponds to the N-MOS transistor 721 or 722 according to the first embodiment, the N-MOS transistor 821 or 822 according to the second embodiment or the N-MOS transistor according to the alternative examples of these embodiments.

On the other hand, the feedback inverter 70f has a semiconductor layer 75f, a gate electrode 76f and a drain electrode 77f, and has a P-MOS transistor 73 and an N-MOS transistor 74 that are formed of these components. In addition, the feedback inverter 70f is connected to a power supply line 50b and a power supply line 49a. The power supply line 50b is connected to the high-potential power supply line 50. The power supply line 49a is connected to the low-potential power supply line 49.

The P-MOS transistor 73 corresponds to the P-MOS transistor 731 or 732 according to the first embodiment, the P-MOS transistor 831 or 832 according to the second embodiment or the P-MOS transistor according to the alternative examples of these embodiments. The N-MOS transistor 74 corresponds to the N-MOS transistor 741 or 742 according to the first embodiment, the N-MOS transistor 841 or 842 according to the second embodiment or the N-MOS transistor according to the alternative examples of these embodiments.

First, the transfer inverter 70t will be described in detail. The semiconductor layer 75t of the transfer inverter 70t is formed in a substantially W shape such that the substantially U-shaped two portions in plan view are coupled at the distal ends of the U-shaped arms. The upper U-shaped portion of the semiconductor layer 75t in the drawing constitutes the double-gate P-MOS transistor 71. The lower U-shaped portion of the semiconductor layer 75t in the drawing constitutes the double-gate N-MOS transistor 72.

The gate electrode 76t extends vertically in the drawing to cross over the four arms of the semiconductor layer 75t. Two channel regions of the P-MOS transistor 71 and two channel regions of the N-MOS transistor 72 are respectively formed at four portions at which the semiconductor layer 75t intersects with the gate electrode 76t. A contact hole H17 is formed at the distal end portion, adjacent to the feedback inverter 70f, of the gate electrode 76t. The gate electrode 76t is connected through the contact hole H17 to the drain electrode 77f (output terminal) of the feedback inverter 70f.

A contact hole H7 is formed at the distal end of the upper-side arm of the semiconductor layer 75t in the drawing. The semiconductor layer 75t (source terminal of the P-MOS transistor 71) is connected through the contact hole H7 to the power supply line 50a. The power supply line 50a extends from a position, at which the contact hole H7 is formed, toward the high-potential power supply line 50 and is connected to the high-potential power supply line 50 through a contact hole H10 that is formed at a position that overlaps the high-potential power supply line 50.

A contact hole H8 is formed at a middle-portion end of the semiconductor layer 75t. The semiconductor layer 75t (drain terminals of the P-MOS transistor 71 and N-MOS transistor 72) is connected to the drain electrode 77t through the contact hole H8. The drain electrode 77t extends linearly from a position, at which the contact hole H8 is formed, toward the outside of the semiconductor layer 75, and has a wide region at its distal end portion. A contact hole H12 is formed at the wide region at the distal end of the drain electrode 77t, and the pixel electrode 35 (not shown) is connected through the contact hole H12 to the drain electrode 77t. In addition, a contact hole H11 is formed in the linear portion of the drain electrode 77t. The drain electrode 77t is connected through the contact hole H11 to the gate electrode 76f of the feedback inverter 70f.

A contact hole H9 is formed at the distal end of the lower-side arm of the semiconductor layer 75t. The semiconductor layer 75t (source terminal of the N-MOS transistor 72) is connected through the contact hole H9 to the power supply line 49a. The power supply line 49a extends from a position, at which the contact hole H9 is formed, toward the low-potential power supply line 49 and is connected to the low-potential power supply line 49 through a contact hole H13 that is formed at a position that overlaps the low-potential power supply line 49.

Next, the feedback inverter 70f will be described in detail. The semiconductor layer 75f is formed in a substantially W shape such that the substantially U-shaped two portions in plan view are coupled, and contact holes H14, H15 and H16 are formed at the distal end portions of the arms. The upper U-shaped portion of the semiconductor layer 75f in the drawing constitutes the double-gate N-MOS transistor 74. The lower U-shaped portion of the semiconductor layer 75f in the drawing constitutes the double-gate P-MOS transistor 73.

The gate electrode 76f extends vertically in the drawing to cross over the four arms of the semiconductor layer 75f. Two channel regions of the P-MOS transistor 73 and two channel regions of the N-MOS transistor 74 are respectively formed at four portions at which the semiconductor layer 75f intersects with the gate electrode 76f. The gate electrode 76f extends toward the transfer inverter 70t and is connected to the drain electrode 77t (output terminal) of the transfer inverter 70t at its distal end.

The semiconductor layer 75f (source terminal of the N-MOS transistor 74) is connected to the power supply line 49a through the contact hole H14 formed at the upper side of the semiconductor layer 75f in the drawing. The power supply line 49a is formed in an L shape in plan view, and the contact hole H14 is formed at a bend of the power supply line 49a.

The semiconductor layer 75f (drain terminals of the P-MOS transistor 73 and N-MOS transistor 74) is connected to the drain electrode 77f and the connecting wire 78 through a contact hole H15 formed at the middle portion of the semiconductor layer 75f in the drawing. The drain electrode 77f extends from a position, at which the contact hole H15 is formed, toward the transfer inverter 70t, and is connected to the gate electrode 76t (input terminal) of the transfer inverter 70t through the contact hole H17. The connecting wire 78 extends from a position, at which the contact hole H15 is formed, toward the driving TFT 41, and is connected to the drain electrode 41e of the driving TFT 41 through a contact hole H6 that is formed at the distal end of the connecting wire 78.

Note that in the present embodiment, the drain electrode 77f is formed in the source wiring layer, and the connecting wire 78 is formed in the gate wiring layer. In this case, the contact hole H15 includes two contact holes that are formed at positions that overlap each other in plan view. That is, the contact hole H15 includes a lower layer-side contact hole and an upper layer-side contact hole. The lower layer-side contact hole is formed to extend through the interlayer insulating film between the gate wiring layer and the semiconductor forming layer and connects the connecting wire 78 with the semiconductor layer 75f. The upper layer-side contact hole is formed to extend through the interlayer insulating film between the source wiring layer and the gate wiring layer and connects the drain electrode 77f with the connecting wire 78. On the other hand, the drain electrode 77f, the connecting wire 78 and the drain electrode 41e of the driving TFT 41 may be formed as a single wire formed in the source wiring layer. In this case, the contact hole H15 is a single contact hole that extends from the source wiring layer to the semiconductor forming layer.

The semiconductor layer 75f (source terminal of the P-MOS transistor 73) is connected through the contact hole H16 to the power supply line 50b. The power supply line 50b extends to the high-potential power supply line 50, and is connected to the high-potential power supply line 50 through a contact hole H17 that is formed at a position that overlaps the high-potential power supply line 50.

Next, the detailed configuration of the latch circuit applied to the thus configured pixel 40 will be described with reference to FIG. 22 to FIG. 27B as first to sixth example embodiments.

### First Example Embodiment

A first example embodiment is a specific pixel configuration of the electrophoretic display device according to the above described first embodiment. FIG. 22 is a plan view that shows a relevant portion of the latch circuit 701 according to the first example embodiment. The latch circuit 701 may be used in place of the latch circuit 70 shown in FIG. 21. Note that FIG. 22 shows only the transfer inverter 701t and the feedback inverter 701f within the latch circuit 701 shown in FIG. 2A. In addition, in FIG. 22, because the latch circuit is shown in correspondence with the circuit arrangement of FIG. 2A, the feedback inverter 701f shown in the drawing is rotated by 180 degrees with respect to that of FIG. 21.

The transfer inverter 701t has the semiconductor layer 75t and the gate electrode 76t. The upper substantially U-shaped portion of the semiconductor layer 75t in the drawing constitutes the P-MOS transistor 711. The lower substantially U-shaped portion of the semiconductor layer 75t constitutes the N-MOS transistor 721. In the present example embodiment, the width (thickness) of the U-shaped arms in the semiconductor layer 75t varies among the portions, and the width Wp1 of the semiconductor layer 75t at a portion that constitutes the P-MOS transistor 711 is larger than the width Wn1 of the semiconductor layer 75t at a portion that constitutes the N-MOS transistor 721.

The feedback inverter 701f has the semiconductor layer 75f and the gate electrode 76f. The upper substantially U-shaped portion of the semiconductor layer 75f in the drawing constitutes the P-MOS transistor 731. The lower substantially U-shaped portion of the semiconductor layer 75f constitutes the N-MOS transistor 741. In the present example embodiment, the width (thickness) of the U-shaped arms in the semiconductor layer 75f varies among the portions, and the width Wp2 of the semiconductor layer 75f at a portion that constitutes the P-MOS transistor 731 is smaller than the width Wn2 of the semiconductor layer 75f at a portion that constitutes the N-MOS transistor 741.

Then, the width Wp1 of the semiconductor layer 75t of the P-MOS transistor 711 is substantially equal to the width Wn2 of the semiconductor layer 75f of the N-MOS transistor 741, and the width Wn1 of the semiconductor layer 75t of the N-MOS transistor 721 is substantially equal to the width Wp2 of the semiconductor layer 75f of the P-MOS transistor 731.

Thus, in the latch circuit 701 of the present example embodiment, the channel width Wp1 of the P-MOS transistor 711 is larger than the channel width Wp2 of the P-MOS transistor 731, and the channel width Wn1 of the N-MOS transistor 721 is smaller than the channel width Wn2 of the N-MOS transistor 741.

In addition, FIG. 22 also schematically shows the electrical connecting structure in the latch circuit 701. The contact holes H7 to H9 and H14 to H16 formed in the semiconductor layers 75t and 75f are connecting portions that are connected to the power supply lines, the drain electrodes and the semiconductor layers as shown in FIG. 21.

The latch circuit 701 is supplied with a high electric potential Vdd through the contact holes H7 and H16, and the latch circuit 701 is supplied with a low electric potential Vss through the contact holes H9 and H14. The output terminal of the transfer inverter 701t is connected through the contact hole H8 to the input terminal of the feedback inverter 701f, and the output terminal of the feedback inverter 701f is connected through the contact hole H15 to the input terminal of the transfer inverter 701t. Note that the above connecting structure is similar to those in the following second to sixth example embodiments, and is not shown in the drawings in the following example embodiments.

As described in detail above, the latch circuit 701 according to the above first embodiment may be easily implemented in such a manner that the width of each of the semiconductor layers 75t and 75f are varied among the portions as shown in FIG. 22. In addition, although not shown in the drawing, the second pixel 402 shown in FIG. 2B may also be easily implemented in such a manner that only the width of each of the semiconductor layers 75t and 75f is adjusted. Note that as long as the size of the channel width satisfies the above relationship between the P-MOS transistors and between the N-MOS transistors, the channel width Wp1 may be different in size from the channel width Wn2, and the channel width Wn1 may be different in size from the channel width Wn2.

### Second Example Embodiment

A second example embodiment is a specific pixel configuration of the electrophoretic display device according to the above described first alternative example of the first embodiment. FIG. 23 is a plan view that shows a relevant portion of the latch circuit 701 according to the second example embodiment. The latch circuit 701 may be used in place of the latch circuit 70 shown in FIG. 21. Note that FIG. 23 is a view corresponding to FIG. 22 according to the above first example embodiment, so like reference numerals denote like components to those in FIG. 22, and the detailed description thereof is omitted.

In the latch circuit 701 of the present example embodiment, the width of the semiconductor layer 75t of the transfer inverter 701t and the width of the semiconductor layer 75f of the feedback inverter 701f are respectively uniform, but the width of each of the gate electrodes 76t and 76f is varied among the portions.

That is, in the gate electrode 76t of the transfer inverter 701t, the width Lp1 of the portion that constitutes the P-MOS transistor 711 is narrower than the width Ln1 of the portion that constitutes the N-MOS transistor 721. On the other hand, in the gate electrode 76f of the feedback inverter 701f, the width Lp2 of the portion that constitutes the P-MOS transistor 731 is wider than the width Ln2 of the portion that constitutes the N-MOS transistor 741. Then, the width Lp1 of the gate electrode 76t of the P-MOS transistor 711 is substantially equal to the width Ln2 of the gate electrode 76f of the N-MOS transistor 741 of the feedback inverter 701f, and the width Ln1 of the gate electrode 76t of the N-MOS transistor 721 is substantially equal to the width Lp2 of the gate electrode 76f of the P-MOS transistor 731.

Thus, in the latch circuit 701 of the present example embodiment, the channel length (the length of the semiconductor layer 75t in a direction in which a carrier moves at a position that intersects with the gate electrode 76t) Lp1 of the P-MOS transistor 711 of the transfer inverter 701t is smaller than the channel length Lp2 of the P-MOS transistor 731 of the feedback inverter 701f, and the channel length Ln1 of the N-MOS transistor 721 of the transfer inverter 701t is larger than the channel length Ln2 of the N-MOS transistor 741 of the feedback inverter 701f.

As described in detail above, the latch circuit 701 according to the above first alternative example of the first embodiment may be easily implemented in such a manner that the width of each of the gate electrodes 76t and 76f is varied among the portions as shown in FIG. 23. In addition, although not shown in the drawing, the second pixel 402 shown in FIG. 2B may also be easily implemented in such a manner that only the width of each of the gate electrodes 76t and 76f is adjusted. Note that as long as the size of the channel length satisfies the above relationship between the P-MOS transistors and between the N-MOS transistors, the channel length Lp1 may be different in size from the channel length Ln2, and the channel length Ln1 may be different in size from the channel length Ln2.

### Third Example Embodiment

A third example embodiment is a specific pixel configuration of the electrophoretic display device according to the above described second alternative example of the first embodiment. FIG. 24 is a plan view that shows a relevant portion of the latch circuit 701 according to the third example embodiment. The latch circuit 701 may be used in place of the latch circuit 70 shown in FIG. 21. Note that FIG. 24 is a view corresponding to FIG. 22 according to the above first example embodiment, so like reference numerals denote like components to those in FIG. 22, and the detailed description thereof is omitted.

In the latch circuit 701 of the present example embodiment, the transfer inverter 701t and the feedback inverter 701f each have transistors having the different numbers of gates. That is, the transfer inverter 701t has the double-gate P-MOS transistor 711 and the triple-gate N-MOS transistor 721, and the feedback inverter 701f has the triple-gate P-MOS transistor 731 and the double-gate N-MOS transistor 741.

The semiconductor layer 75t of the transfer inverter 701t is formed in a meander shape so as to zigzag cross over the rectangular gate electrode 76t that extends vertically in the drawing. The upper substantially U-shaped portion of the semiconductor layer 75t in the drawing constitutes the P-MOS transistor 711. The lower substantially S-shaped portion of the semiconductor layer 75t constitutes the N-MOS transistor 721. The semiconductor layer 75f of the feedback inverter 701f is also formed in a meander shape similar to that of the semiconductor layer 75t. The upper substantially S-shaped portion of the semiconductor layer 75f in the drawing constitutes the P-MOS transistor 731. The lower substantially U-shaped portion of the semiconductor layer 75f constitutes the N-MOS transistor 741.

As described in detail above, the latch circuit 701 according to the above second alternative example of the first embodiment may be easily implemented in such a manner that the shape of each of the semiconductor layers 75t and 75f is changed and the number of portions that intersect with the gate electrode 76t or 76f is varied as shown in FIG. 24. In addition, although not shown in the drawing, the second pixel 402 shown in FIG. 2B may also be easily implemented in such a manner that only the shape of each of the semiconductor layers 75t and 75f is changed. Note that even a single-gate or multi-gate transistor other than the double-gate or triple-gate transistor may also be easily implemented in such a manner that the shape of each of the semiconductor layers 75t and 75f is changed as in the case of the present example embodiment.

### Fourth Example Embodiment

A fourth example embodiment is a specific pixel configuration of the electrophoretic display device according to the above described third alternative example of the first embodiment. FIG. 25 is a plan view that shows a relevant portion of the latch circuit 701 according to the fourth example embodiment. The latch circuit 701 may be used in place of the latch circuit 70 shown in FIG. 21.

Note that FIG. 25 is a view corresponding to FIG. 22 according to the above first example embodiment, so like reference numerals denote like components to those in FIG. 22, and the detailed description thereof is omitted.

In the latch circuit 701 of the present example embodiment, although the channel width and channel length of each of the transistors that constitute the transfer inverter 701t and the feedback inverter 701f are equal, the length, in a direction in which a carrier moves, of the LDD region (low concentration impurity region) formed in each transistor is varied among the transistors.

In the P-MOS transistor 711 of the transfer inverter 701t, LDD regions 75L1 are formed on both sides of the regions (channel regions) that overlap the gate electrode 76t of the semiconductor layer 75t. In the N-MOS transistor 721, LDD regions 75L2 are formed on both sides of the channel regions of the semiconductor layer 75t. The length (LDD length) LDp1, in a direction in which a carrier moves, of each LDD region 75L1 of the P-MOS transistor 711 is smaller than the LDD length LDn1 of the N-MOS transistor 721.

On the other hand, in the P-MOS transistor 731 of the feedback inverter 701f, LDD regions 75L3 are formed on both sides of the channel regions of the semiconductor layer 75f. In the N-MOS transistor 741, LDD regions 75L4 are formed on both side of the channel regions of the semiconductor layer 75f. The LDD length LDp2 of the P-MOS transistor 731 is smaller than the LDD length LDn2 of the N-MOS transistor 741.

Then, the LDD length LDp1 of the P-MOS transistor 711 is substantially equal to the LDD length LDn2 of the N-MOS transistor 741 of the feedback inverter 701f, and the LDD length LDn1 of the N-MOS transistor 721 is substantially equal to the LDD length LDp2 of the P-MOS transistor 731.

Thus, in the latch circuit 701 of the present example embodiment, the LDD length LDp1 of the P-MOS transistor 711 of the transfer inverter 701t is smaller than the LDD length LDp2 of the P-MOS transistor 731 of the feedback inverter 701f, and the LDD length LDn1 of the N-MOS transistor 721 of the transfer inverter 701t is larger than the LDD length LDn2 of the N-MOS transistor 741 of the feedback inverter 701f.

As described in detail above, the latch circuit 701 according to the above third alternative example of the first embodiment may be easily implemented in such a manner that the impurity implantation region in each of the semiconductor layers 75t and 75f of the inverters is adjusted as shown in FIG. 25. In addition, although not shown in the drawing, the second pixel 402 shown in FIG. 2B may also be easily implemented in such a manner that only the impurity implantation region is adjusted. Note that as long as the size of the LDD length satisfies the above relationship between the P-MOS transistors and between the N-MOS transistors, the LDD length LDp1 may be different in size from the LDD length LDn2, and the LDD length LDn1 may be different in size from the LDD length LDn2.

### Fifth Example Embodiment

A fifth example embodiment is a specific pixel configuration of the electrophoretic display device according to the above described second embodiment. FIG. 26 is a plan view that shows a relevant portion of the latch circuit 801 according to the fifth example embodiment. The latch circuit 801 may be used in place of the latch circuit 70 shown in FIG. 21. Note that FIG. 26 is a view corresponding to FIG. 22 according to the above first example embodiment, so like reference numerals denote like components to those in FIG. 22, and the detailed description thereof is omitted.

In the latch circuit 801 of the present example embodiment, the capacitor C1 that uses the drain electrode 77f of the feedback inverter 801f as one of the electrodes is provided. That is, a capacitor electrode 79 is formed at a position that overlaps the drain electrode 77f in plan view, and the drain electrode 77f is connected through the contact hole H15 to the semiconductor layer 75f of the feedback inverter 701f. As shown in FIG. 21, the drain electrode 77f is connected to the gate electrode 76t of the transfer inverter 70t, so the capacitor C1 is connected to the input terminal of the transfer inverter 801t and the output terminal of the feedback inverter 801f. Note that in FIG. 26, the direction in which the drain electrode 77f extends is changed for easy understanding of the drawing.

The capacitor electrode 79 is connected to the low-potential power supply line 49 shown in FIG. 21, and is held at the low electric potential Vss during operation. When another constant-potential wire is formed near the pixel, the capacitor electrode 79 may be connected to the constant-potential wire. In addition, in the case of the present example embodiment, because the drain electrode 77f is formed in the source wiring layer, the capacitor electrode 79 may be formed in the gate wiring layer or the semiconductor forming layer. When the capacitor electrode 79 is formed in the gate wiring layer, the capacitor electrode 79 may be formed at the same time when the gate electrodes 76t and 76f are formed. On the other hand, when the capacitor electrode 79 is formed in the semiconductor forming layer, the capacitor electrode 79 may be formed at the same time when the semiconductor layers 75t and 75f are formed. When the semiconductor film is used for the capacitor electrode 79, high-concentration impurities are implanted to form a film having a high conductivity as in the case of the high-concentration impurity regions of the semiconductor layers 75t and 75f.

Note that as shown in FIG. 21, because the output terminal of the feedback inverter 801f is connected to not only the drain electrode 77f but also the connecting wire 78, the capacitor C1 may be formed using the connecting wire 78. That is, the capacitor electrode 79 may be formed at a position that overlaps the connecting wire 78 in plan view. When the connecting wire 78 is used as one of the electrodes as described above, because the connecting wire 78 is formed in the gate wiring layer, the capacitor electrode 79 may be formed in the source wiring layer or in the semiconductor forming layer.

As described in detail above, the latch circuit 801 according to the second embodiment may be easily implemented in such a manner that the capacitor electrode 79 is formed by using the laminated structure of the plurality of wiring layers as shown in FIG. 26. In addition, although not shown in the drawing, the latch circuit 802 of the second pixel 502 shown in FIG. 6B may also be easily implemented in such a manner that the capacitor C2 that uses the drain electrode 77t of the transfer inverter 801t as one of the electrodes is formed.

### Sixth Example Embodiment

A sixth example embodiment is a specific pixel configuration of the electrophoretic display device according to the above described alternative example of the second embodiment. FIG. 27B is a plan view that shows a relevant portion of the latch circuit 801A according to the sixth example embodiment. The latch circuit 801A may be used in place of the latch circuit 70 shown in FIG. 21. Note that FIG. 27B is a view corresponding to FIG. 22 according to the above first example embodiment, so like reference numerals denote like components to those in FIG. 22, and the detailed description thereof is omitted.

In the latch circuit 801A of the present example embodiment, the resistance element R1 is provided for the power supply line 50b that supplies the high electric potential Vdd to the feedback inverter 801f. In the case of the present example embodiment, the resistance element R1 is formed in such a manner that the width of the power supply line 50b is partially narrowed and then the narrow width wire is arranged in a meander shape. That is, the width of the power supply line 50b is narrowed to increase a wire resistance, and is arranged in a meander shape to increase the wire length of the narrow width portion. Thus, the resistance element R1 having a desired resistance is formed.

As described in detail above, the latch circuit 801A according to the alternative example of the second embodiment may be easily implemented in such a manner that the planar shape of the power supply line 50b connected to the feedback inverter 801f is changed as shown in FIG. 27B. In addition, although not shown in the drawing, when the latch circuit is formed in correspondence with the latch circuit 802 of the second pixel 502, a similar resistance element may be formed in the power supply line 50a that supplies the high electric potential Vdd to the transfer inverter 801t.

The entire disclosure of Japanese Patent Application Nos: 2008-066225, filed Mar. 14, 2008 and 2008-247701, filed Sep. 26, 2008 are expressly incorporated by reference herein.

What is claimed is:

1. An electrophoretic display device comprising:
a display unit that is formed so that electrophoretic elements containing electrophoretic particles are held between a pair of substrates, wherein
the display unit is formed of a plurality of pixels, each of which includes a pixel electrode, a pixel switching element, and a latch circuit connected between the pixel electrode and the pixel switching element, wherein
a plurality of the pixels located in at least portion of the display unit each are any one of a first pixel and a second pixel, wherein
the first pixel satisfies a relationship that the gate capacitance charging time of a P-MOS transistor of a transfer inverter of the latch circuit is shorter than the gate capacitance charging time of a P-MOS transistor of a feedback inverter of the latch circuit, a relationship that the gate capacitance charging time of an N-MOS transistor of the transfer inverter is longer than the gate capacitance charging time of an N-MOS transistor of the feedback inverter, or both the relationships, and wherein
the second pixel satisfies a relationship that the gate capacitance charging time of a P-MOS transistor of a transfer inverter of the latch circuit is longer than the gate capacitance charging time of a P-MOS transistor of a feedback inverter of the latch circuit, a relationship that the gate capacitance charging time of an N-MOS transistor of the transfer inverter is shorter than the gate capacitance charging time of an N-MOS transistor of the feedback inverter, or both the relationships.

2. The electrophoretic display device according to claim 1, wherein
a plurality of the pixels located in at least portion of the display unit each are any one of a first pixel and a second pixel, wherein in the first pixel, the channel width of a P-MOS transistor of a transfer inverter of the latch circuit is larger than the channel width of a P-MOS transistor of a feedback inverter of the latch circuit, and the channel width of an N-MOS transistor of the transfer inverter is smaller than the channel width of an N-MOS transistor of the feedback inverter, and wherein
in the second pixel, the channel width of a P-MOS transistor of a transfer inverter of the latch circuit is smaller than the channel width of a P-MOS transistor of a feedback inverter of the latch circuit, and the channel width of an N-MOS transistor of the transfer inverter is larger than the channel width of an N-MOS transistor of the feedback inverter.

3. The electrophoretic display device according to claim 1, wherein
a plurality of the pixels located in at least portion of the display unit each are any one of a first pixel and a second pixel, wherein
in the first pixel, the channel length of a P-MOS transistor of a transfer inverter of the latch circuit is smaller than the channel length of a P-MOS transistor of a feedback inverter of the latch circuit, and the channel length of an N-MOS transistor of the transfer inverter is larger than the channel length of an N-MOS transistor of the feedback inverter, and wherein
in the second pixel, the channel length of a P-MOS transistor of a transfer inverter of the latch circuit is larger than the channel length of a P-MOS transistor of a feedback inverter of the latch circuit, and the channel length of an N-MOS transistor of the transfer inverter is smaller than the channel length of an N-MOS transistor of the feedback inverter.

4. The electrophoretic display device according to claim 1, wherein
a plurality of the pixels located in at least portion of the display unit each are any one of a first pixel and a second pixel, wherein
in the first pixel, the number of gates of a P-MOS transistor of a transfer inverter of the latch circuit is smaller than the number of gates of a P-MOS transistor of a feedback inverter of the latch circuit, and the number of gates of an N-MOS transistor of the transfer inverter is larger than the number of gates of an N-MOS transistor of the feedback inverter, and wherein
in the second pixel, the number of gates of a P-MOS transistor of a transfer inverter of the latch circuit is larger than the number of gates of a P-MOS transistor of a feedback inverter of the latch circuit, and the number of gates of an N-MOS transistor of the transfer inverter is smaller than the number of gates of an N-MOS transistor of the feedback inverter.

5. The electrophoretic display device according to claim 1, wherein
a plurality of the pixels located in at least portion of the display unit each are any one of a first pixel and a second pixel, wherein
in the first pixel, the LDD length of a P-MOS transistor of a transfer inverter of the latch circuit is smaller than the LDD length of a P-MOS transistor of a feedback inverter of the latch circuit, and the LDD length of an N-MOS transistor of the transfer inverter is larger than the LDD length of an N-MOS transistor of the feedback inverter, and wherein
in the second pixel, the LDD length of a P-MOS transistor of a transfer inverter of the latch circuit is larger than the LDD length of a P-MOS transistor of a feedback inverter of the latch circuit, and the LDD length of an N-MOS transistor of the transfer inverter is smaller than the LDD length of an N-MOS transistor of the feedback inverter.

6. The electrophoretic display device according to claim 1, wherein
a plurality of the pixels located in at least portion of the display unit each are any one of a first pixel and a second pixel, wherein
the first pixel has a capacitor, of which one of electrodes is connected to an input terminal of a transfer inverter of the latch circuit, and wherein
the second pixel has a capacitor, of which one of electrodes is connected to an input terminal of a feedback inverter of the latch circuit.

7. The electrophoretic display device according to claim 1, wherein
a plurality of the pixels located in at least portion of the display unit each are any one of a first pixel and a second pixel, wherein
the first pixel has a resistance element connected between a feedback inverter of the latch circuit and a high-potential power supply line, and wherein
the second pixel has a resistance element connected between a transfer inverter of the latch circuit and a high-potential power supply line.

8. The electrophoretic display device according to claim 6, wherein the other one of the electrodes of the capacitor is connected to a low-potential power supply line together with a low-potential power supply terminal of the latch circuit.

9. The electrophoretic display device according to claim 1, wherein the at least portion of the display unit each is formed of only any one of the first pixel and the second pixel.

10. The electrophoretic display device according to claim 1, wherein each pixel includes a switch circuit that is connected between the latch circuit and the pixel electrode and that is connected between first and second control lines provided for the display unit.

11. The electrophoretic display device according to claim 1, wherein an initial image display period during which an operation to supply power to each latch circuit and an operation to apply a voltage to each electrophoretic element without inputting an image signal to each latch circuit are executed are provided.

12. The electrophoretic display device according to claim 1, further comprising:
a control unit that controls driving of the display unit; and
a power supply voltage monitoring circuit that is connected to the control unit and that monitors a power supply voltage, wherein
the control unit is configured to execute a stand-by step in which power supplied to the display unit is interrupted on the basis of an alarm signal output from the power supply voltage monitoring circuit and an initial image display step in which power is supplied to the display unit and a voltage is applied to each electrophoretic element.

13. The electrophoretic display device according to claim 12, wherein in the stand-by step, power supplied to a portion of circuits of the control unit is interrupted.

14. A driving method for the electrophoretic display device according to claim 1, comprising:
displaying an initial image on the display unit by supplying power to each latch circuit in a turn-off state and applying a voltage to each electrophoretic element through each pixel electrode.

15. The driving method according to claim 14, wherein the initial image is displayed on the display unit when the electrophoretic display device starts up.

16. The driving method according to claim 14, wherein the initial image is displayed between a period during which at least each latch circuit is turned off and an image display period during which image data are transferred to the display unit and then an image based on the image data is displayed.

17. The driving method according to claim 14, wherein the electrophoretic display device includes a power supply voltage monitoring circuit that monitors a power supply voltage, and wherein an alarm image is displayed on the display unit when the power supply voltage monitoring circuit detects that the power supply voltage is lower than a predetermined value.

18. The driving method according to claim 17, further comprising interrupting power supplied to a portion of circuits of the electrophoretic display device before the initial image is displayed.

19. An electronic apparatus comprising the electrophoretic display device according to claim 1.
